(19) United States
(12) Patent Application Publication
(10) Pub. No.: US 2026/0269939 A1
(43) Pub. Date: Sep. 10, 2026

(54) Determining and Using Application Limitations During Direct-to-Cell Satellite Coverage

(71) Applicants: AT&T Mobility II LLC, Atlanta, GA (US); AT&T Intellectual Property I, L.P., Atlanta, GA (US)

(72) Inventors: Nathan Stowell, Lake Stevens, WA (US); Zhengyi Zhou, Chappaqua, NY (US); Rashmi Palamadai, Naperville, IL (US); Yupeng Jia, South Pasadena, CA (US)

(73) Assignees: AT&T Mobility II LLC, Atlanta, GA (US); AT&T Intellectual Property I, L.P., Atlanta, GA (US)

(21) Appl. No.: 19/075,222

(22) Filed: Mar. 10, 2025

(51) Int. Cl. H04B 7/185; H04W 80/12

(52) U.S. Cl. CPC H04B 7/18547; H04B 7/18539; H04W 80/12

(57) ABSTRACT

Determining and using application limitations during direct-to-cell satellite coverage can include obtaining coverage data that represents network connections that are expected to be available for the user device at an expected geographic location at a future time and identifying mobile applications that are installed at the user device. An application limitation can be determined, the application limitation corresponding to a feature of the mobile applications that is to be limited when the user device is connected to a direct-to-cell satellite network connection. The user device can generate a user interface that includes a representation of the feature that is to be limited.

### BACKGROUND

Some modern computing devices such as smartphones, smartwatches, vehicle computing systems, and the like, can include multiple transceivers for conducting communications over one or more networks. At some times, tracking what network a device is communicating with can be complicated, and because network conditions can change rapidly, it may be difficult for a user to stay informed about current connections, connection statuses, and/or connection options at any given time.

### SUMMARY

The present disclosure is directed to determining and using application limitations during direct-to-cell satellite coverage. A user device such as a smartphone, a vehicle computer system, or the like can execute a coverage management application or other application to determine (or obtain information identifying) a geographic location of the user device and movement of the user device, to detect when network connections associated with the user device are expected to change, and possible connection limitations associated with the network connections. Based on the changes to network connections, the user device can further execute the coverage management application to detect mobile applications installed at the user device, features and/or functionality of the mobile applications that will be limited or restricted based on the network connection changes, and times associated with those limitations or restrictions such as start times, durations, end times, and the like.

In various embodiments, the geographic location of the user device can be determined using a location device such as a global positioning system (“GPS”) receiver or other location determination system or device and/or the user device may receive information identifying its geographic location from other devices or entities such as location servers, network devices, or the like. The user device also can be configured to determine movements and/or motion of the user device by accessing a motion processor, sensors, and/or devices to determine motion, orientation, and/or movements of the user device. The user device can also be configured to identify and/or determine one or more network connections available, unavailable, active, and/or inactive for the user device. The user device can generate device data that can represent the location of the user device, movements of the user device, and/or network connections for the user device as determined by the user device. The user device can also add, to the device data, identity data that identifies the user device and/or a user or account associated with the user device, contextual information that can describe future locations and/or times associated with those locations (e.g., from routing software, calendar applications, or the like), and/or other data. The user device can provide the device data to a recipient such as the coverage management service and/or the server computer that hosts and/or executes the coverage management service. The coverage management service can use the device data to generate and/or update the user database, to create and/or update coverage data, and/or for other purposes.

A server computer can host and/or execute the coverage management service. The server computer can obtain the device data from the user device and/or other device or entity. The server computer can determine, based on the device data, one or more locations of the device (e.g., the user device) at one or more future times. In some embodiments, the server computer can determine the expected location by analyzing location data and motion data. In some embodiments, for example, the motion data can include a vector that can define a heading and speed of the user device. Thus, the server computer can predict the location of the user device by applying the vector to the location of the user device over some time to predict, project, and/or extrapolate the location of the user device at one or more times in the future. In some other embodiments, the server computer can determine an expected location for the user device at some time in the future by accessing contextual information such as, for example, routing information (e.g., the user device may be used to navigate to a destination, so the destination can be projected to be the future location of the user device at a time corresponding to the arrival time, for example), calendar information (e.g., a location of an appointment at an appointment time can correspond to an expected location at a particular time, etc.), or the like. Thus, the server computer can determine, in multiple manners, one or more locations of the user device at which the user device is expected to be located at one or more times in the future.

The server computer can use the determined locations and times to identify network connections that are expected to be available at the times and locations. The server computer may determine, for example, that a coverage area associated with a particular satellite of a direct-to-cell satellite network is projected or predicted to be at a first location at a first time and at a second location at a second time. The server computer also can determine one or more other network connections that may be expected to be available at the locations and times identified. The server computer can generate coverage data that can identify network connections available at various locations over various times. The server computer can send the coverage data to the user device for use in generating one or more user interfaces.

When generating the coverage data, the server computer can also be configured to determine time, location, and/or other limitations for the identified network connections. Thus, for example, the server computer can determine, for a satellite connection at a particular location, any limits in terms of time, location, or the like. These limits can be added to the coverage data. Also, the server computer can be configured to determine, in some embodiments, one or more mobile applications installed at the user device and/or functionality of those mobile applications. In some embodiments, the server computer can be configured to access an application feature service and/or an application catalog to determine features of the mobile applications, and this information can be used to determine one or more application restrictions or limitations that are to exist when the network connections change in some instances. In various embodiments, the identification of the mobile applications, the features and/or functions thereof, and any limitations that will apply when the user device is connected to some network connections can be determined by the user device (e.g., by executing the coverage management application) without any action by the server computer. In any event, the server computer can create the coverage data (with or without application limitations information) and provide the coverage data to the user device for use in generating user interfaces and/or user interface elements at the user device.

The user device can obtain the coverage data and output the coverage data at the device (e.g., the user device). The user device can be configured to determine what application limitations or restrictions may exist when the network connection changes, and generate one or more user interfaces and/or user interface elements based on the coverage data and the application information. Thus, for example, the user device can be configured to display one or more indicators that indicate active and/or available network connections, inactive and/or unavailable network connections, network connection status information, a time until a network connection will be available and the like, as well as application limitations or restrictions that may be imposed when the network connection changes. Thus, embodiments of the concepts and technologies disclosed herein can be used to provide, to a user or other entity, visual information that can indicate active and/or inactive network connections, time until a network connection is available, identities of primary and/or secondary (or backup) network connections, application limitations and/or restrictions that apply at various times, combinations thereof, or the like. It should be understood that this example embodiment is illustrative, and therefore should not be construed as being limiting in any way.

In some embodiments, a user device may be connected to a local network and a wireless network at a first time and while at or near a first location. At this time, the user device may have access to a first group of mobile applications and/or associated features of the mobile applications. The user device may allow unrestricted access to the first group of features and/or functions of the mobile applications at the first time and while at or near a first location, with the first group corresponding to all mobile applications installed at the user device. As the user device moves (e.g., along a device path) away from the first location, the connectivity of the user device with the local network and the wireless network may change in terms of signal strength and the like. As such, embodiments of the concepts and technologies disclosed herein can enable the user device (e.g., via execution of the coverage management application) and/or the server computer (e.g., via execution of the coverage management service) to determine, based on the device data, the network data, the user database, and/or other information, that a connection with a direct-to-cell satellite network may be desirable and/or necessary.

For example, the user device and/or the server computer may determine that a connection with the local network and/or the wireless network will be unavailable and/or not strong enough to provide good quality of service (“QoS”) for the user device at a second time and second location, with “good QoS” corresponding in various embodiments to a QoS at which all applications and/or functions of the user device can function properly (e.g., data communications are fast enough to support data communications between the user device and other entities at a rate that provides baseline normal application execution). Thus, the concepts and technologies disclosed herein for determining network connections at a later time (e.g., a second time, a third time, or the like) can be used to determine if a connection to a direct-to-cell satellite network is possible and to communicate information relating to such a connection to a user device to improve user experience and/or for other reasons. Furthermore, the user device and/or the server computer can be configured to determine what limitations and/or restrictions should apply to the mobile applications at the second time and second location. For example, the user device can have access to a second group of mobile applications and/or features thereof at the second time and second location, with the second group of mobile applications being something less than all features and/or functionality of all mobile applications installed at the user device. It should be understood that this example embodiment is illustrative, and therefore should not be construed as being limiting in any way.

Additionally, it can be appreciated that embodiments of the concepts and technologies disclosed herein can be used to not only determine when a direct-to-cell satellite connection (e.g., provided by a satellite of the direct-to-cell satellite network) will be available, but also if and when that connection may become unavailable. Similarly, embodiments of the concepts and technologies disclosed herein can determine when some or all limitations or restrictions for the mobile applications will apply and/or when those limitations or restrictions will end. It can be appreciated that the user device may exit the coverage area associated with a satellite of the direct-to-cell satellite network at a third time. This exit may be due to movements of the user device, due to movements of satellites of the direct-to-cell satellite network relative to the earth (e.g., resulting in movement of the coverage area associated with a satellite of the direct-to-cell satellite network), and/or combinations of movements. As such, embodiments of the concepts and technologies disclosed herein can determine overlap of one or more coverage area associated with a satellite of the direct-to-cell satellite network and a geographic location of the user device over time and/or time ranges. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include obtaining, at a user device, device data associated with the user device. The device data can include information that can be analyzed to determine an expected geographic location of the user device at a future time. The operations further can include providing, to a server computer, the device data. The server computer can be configured to determine, based on the device data and network data obtained from a network control, the expected geographic location of the user device at the future time and network connections that are expected to be available at the expected geographic location at the future time. The network connections can include a direct-to-cell satellite network connection. The operations further can include obtaining, from the server computer, coverage data that can represent the network connections that are expected to be available for the user device at the expected geographic location at the future time. The operations further can include identifying mobile applications that are installed at the user device, one of the mobile applications including features; determining, at the user device and based on the mobile applications and the coverage data, an application limitation that can include one of the features that is to be limited when the user device is connected to the direct-to-cell satellite network connection; and generating, at the user device, a user interface including a representation of the one of the features that is to be limited when the user device is connected to the direct-to-cell satellite network connection.

In some embodiments, identifying the mobile applications can include determining features of the mobile applications, the features including the one of the features, and determining the features of the mobile applications can include analyzing the mobile applications. In some embodiments, identifying the mobile applications can include determining features of the mobile applications, the features including the one of the features, and determining the features of the mobile applications can include accessing an application catalog. In some embodiments, the coverage data can indicate a time until the user device is connected to the direct-to-cell satellite network connection. The user interface can include the representation of the one of the features that is to be limited when the user device is connected to the direct-to-cell satellite network connection and the time until the user device is connected to the direct-to-cell satellite network connection, and the user device can present the user interface.

In some embodiments, the operations can further include determining, based on the coverage data, a first time at which the user device is connected to the direct-to-cell satellite network connection and a second time at which the user device disconnects from the direct-to-cell satellite network connection. In some embodiments, the operations can further include presenting the user interface at the user device when the user device is connected to the direct-to-cell satellite network connection. The user interface further can include a representation of a time until the one of the features that is to be limited when the user device is connected to the direct-to-cell satellite network connection will no longer be limited. In some embodiments, determining the application limitation can include determining that all functionality associated with the mobile application is to be limited when the user device is connected to the direct-to-cell satellite network connection.

According to another aspect of the concepts and technologies disclosed herein, a method is disclosed. The method can include obtaining, at a user device that includes a processor, device data associated with the user device. The device data can include information that can be analyzed to determine an expected geographic location of the user device at a future time. The method further can include providing, by the user device and to a server computer, the device data. The server computer can be configured to determine, based on the device data and network data obtained from a network control, the expected geographic location of the user device at the future time and network connections that are expected to be available at the expected geographic location at the future time. The network connections can include a direct-to-cell satellite network connection. The method further can include obtaining, by the user device and from the server computer, coverage data that can represent the network connections that are expected to be available for the user device at the expected geographic location at the future time. The method further can include identifying mobile applications that are installed at the user device, one of the mobile applications including features; determining, at the user device and based on the mobile applications and the coverage data, an application limitation that can include one of the features that is to be limited when the user device is connected to the direct-to-cell satellite network connection; and generating, by the user device, a user interface including a representation of the one of the features that is to be limited when the user device is connected to the direct-to-cell satellite network connection.

In some embodiments, identifying the mobile applications can include determining features of the mobile applications, the features including the one of the features, and determining the features of the mobile applications can include analyzing the mobile applications. In some embodiments, identifying the mobile applications can include determining features of the mobile applications, the features including the one of the features, and determining the features of the mobile applications can include accessing an application catalog. In some embodiments, the coverage data can indicate a time until the user device is connected to the direct-to-cell satellite network connection. The user interface can include the representation of the one of the features that is to be limited when the user device is connected to the direct-to-cell satellite network connection and the time until the user device is connected to the direct-to-cell satellite network connection, and the user device can present the user interface.

In some embodiments, the method can further include determining, based on the coverage data, a first time at which the user device is connected to the direct-to-cell satellite network connection and a second time at which the user device disconnects from the direct-to-cell satellite network connection. In some embodiments, the method can further include presenting the user interface at the user device when the user device is connected to the direct-to-cell satellite network connection. The user interface further can include a representation of a time until the one of the features that is to be limited when the user device is connected to the direct-to-cell satellite network connection will no longer be limited. In some embodiments, determining the application limitation can include determining that all functionality associated with the mobile application is to be limited when the user device is connected to the direct-to-cell satellite network connection.

According to yet another aspect of the concepts and technologies disclosed herein, a computer storage medium is disclosed. The computer storage medium can store computer-executable instructions that, when executed by a processor, cause the processor to perform operations. The operations can include obtaining, at a user device, device data associated with the user device. The device data can include information that can be analyzed to determine an expected geographic location of the user device at a future time. The operations further can include providing, to a server computer, the device data. The server computer can be configured to determine, based on the device data and network data obtained from a network control, the expected geographic location of the user device at the future time and network connections that are expected to be available at the expected geographic location at the future time. The network connections can include a direct-to-cell satellite network connection. The operations further can include obtaining, from the server computer, coverage data that can represent the network connections that are expected to be available for the user device at the expected geographic location at the future time. The operations further can include identifying mobile applications that are installed at the user device, one of the mobile applications including features; determining, at the user device and based on the mobile applications and the coverage data, an application limitation that can include one of the features that is to be limited when the user device is connected to the direct-to-cell satellite network connection; and generating, at the user device, a user interface including a representation of the one of the features that is to be limited when the user device is connected to the direct-to-cell satellite network connection.

In some embodiments, identifying the mobile applications can include determining features of the mobile applications, the features including the one of the features, and determining the features of the mobile applications can include analyzing the mobile applications. In some embodiments, identifying the mobile applications can include determining features of the mobile applications, the features including the one of the features, and determining the features of the mobile applications can include accessing an application catalog. In some embodiments, the coverage data can indicate a time until the user device is connected to the direct-to-cell satellite network connection. The user interface can include the representation of the one of the features that is to be limited when the user device is connected to the direct-to-cell satellite network connection and the time until the user device is connected to the direct-to-cell satellite network connection, and the user device can present the user interface.

In some embodiments, the operations can further include determining, based on the coverage data, a first time at which the user device is connected to the direct-to-cell satellite network connection and a second time at which the user device disconnects from the direct-to-cell satellite network connection. In some embodiments, the operations can further include presenting the user interface at the user device when the user device is connected to the direct-to-cell satellite network connection. The user interface further can include a representation of a time until the one of the features that is to be limited when the user device is connected to the direct-to-cell satellite network connection will no longer be limited. In some embodiments, determining the application limitation can include determining that all functionality associated with the mobile application is to be limited when the user device is connected to the direct-to-cell satellite network connection.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for obtaining information for limiting applications during direct-to-cell satellite coverage, according to an illustrative embodiment of the concepts and technologies described herein.

FIG. 3 is a flow diagram showing aspects of a method for providing information for limiting applications during direct-to-cell satellite coverage, according to an illustrative embodiment of the concepts and technologies described herein.

FIG. 4 is a flow diagram showing aspects of a method for generating coverage data for limiting applications during direct-to-cell satellite coverage, according to an illustrative embodiment of the concepts and technologies described herein.

FIGS. 5A-5G are user interface diagrams showing various screen displays for providing determining and using application limitations during direct-to-cell satellite coverage, according to some illustrative embodiments of the concepts and technologies described herein.

FIG. 6 schematically illustrates a network, according to an illustrative embodiment of the concepts and technologies described herein.

FIG. 7 is a block diagram illustrating an example computer system configured to generate and provide determining and using application limitations during direct-to-cell satellite coverage, according to some illustrative embodiments of the concepts and technologies described herein.

FIG. 8 is a block diagram illustrating an example mobile device configured to interact with a coverage management service, according to some illustrative embodiments of the concepts and technologies described herein.

FIG. 9 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to determining and using application limitations during direct-to-cell satellite coverage. A user device such as a smartphone, a vehicle computer system, or the like can execute a coverage management application or other application to determine (or obtain information identifying) a geographic location of the user device and movement of the user device, to detect when network connections associated with the user device are expected to change, and possible connection limitations associated with the network connections. Based on the changes to network connections, the user device can further execute the coverage management application to detect mobile applications installed at the user device, features and/or functionality of the mobile applications that will be limited or restricted based on the network connection changes, and times associated with those limitations or restrictions such as start times, durations, end times, and the like.

In various embodiments, the geographic location of the user device can be determined using a location device such as a GPS receiver or other location determination system or device and/or the user device may receive information identifying its geographic location from other devices or entities such as location servers, network devices, or the like. The user device also can be configured to determine movements and/or motion of the user device by accessing a motion processor, sensors, and/or devices to determine motion, orientation, and/or movements of the user device. The user device can also be configured to identify and/or determine one or more network connections available, unavailable, active, and/or inactive for the user device. The user device can generate device data that can represent the location of the user device, movements of the user device, and/or network connections for the user device as determined by the user device. The user device can also add, to the device data, identity data that identifies the user device and/or a user or account associated with the user device, contextual information that can describe future locations and/or times associated with those locations (e.g., from routing software, calendar applications, or the like), and/or other data. The user device can provide the device data to a recipient such as the coverage management service and/or the server computer that hosts and/or executes the coverage management service. The coverage management service can use the device data to generate and/or update the user database, to create and/or update coverage data, and/or for other purposes.

A server computer can host and/or execute the coverage management service. The server computer can obtain the device data from the user device and/or other device or entity. The server computer can determine, based on the device data, one or more locations of the device (e.g., the user device) at one or more future times. In some embodiments, the server computer can determine the expected location by analyzing location data and motion data. In some embodiments, for example, the motion data can include a vector that can define a heading and speed of the user device. Thus, the server computer can predict the location of the user device by applying the vector to the location of the user device over some time to predict, project, and/or extrapolate the location of the user device at one or more times in the future. In some other embodiments, the server computer can determine an expected location for the user device at some time in the future by accessing contextual information such as, for example, routing information (e.g., the user device may be used to navigate to a destination, so the destination can be projected to be the future location of the user device at a time corresponding to the arrival time, for example), calendar information (e.g., a location of an appointment at an appointment time can correspond to an expected location at a particular time, etc.), or the like. Thus, the server computer can determine, in multiple manners, one or more locations of the user device at which the user device is expected to be located at one or more times in the future.

The server computer can use the determined locations and times to identify network connections that are expected to be available at the times and locations. The server computer may determine, for example, that a coverage area associated with a particular satellite of a direct-to-cell satellite network is projected or predicted to be at a first location at a first time and at a second location at a second time. The server computer also can determine one or more other network connections that may be expected to be available at the locations and times identified. The server computer can generate coverage data that can identify network connections available at various locations over various times. The server computer can send the coverage data to the user device for use in generating one or more user interfaces.

When generating the coverage data, the server computer can also be configured to determine time, location, and/or other limitations for the identified network connections. Thus, for example, the server computer can determine, for a satellite connection at a particular location, any limits in terms of time, location, or the like. These limits can be added to the coverage data. Also, the server computer can be configured to determine, in some embodiments, one or more mobile applications installed at the user device and/or functionality of those mobile applications. In some embodiments, the server computer can be configured to access an application feature service and/or an application catalog to determine features of the mobile applications, and this information can be used to determine one or more application restrictions or limitations that are to exist when the network connections change in some instances. In various embodiments, the identification of the mobile applications, the features and/or functions thereof, and any limitations that will apply when the user device is connected to some network connections can be determined by the user device (e.g., by executing the coverage management application) without any action by the server computer. In any event, the server computer can create the coverage data (with or without application limitations information) and provide the coverage data to the user device for use in generating user interfaces and/or user interface elements at the user device.

The user device can obtain the coverage data and output the coverage data at the device (e.g., the user device). The user device can be configured to determine what application limitations or restrictions may exist when the network connection changes, and generate one or more user interfaces and/or user interface elements based on the coverage data and the application information. Thus, for example, the user device can be configured to display one or more indicators that indicate active and/or available network connections, inactive and/or unavailable network connections, network connection status information, a time until a network connection will be available and the like, as well as application limitations or restrictions that may be imposed when the network connection changes. Thus, embodiments of the concepts and technologies disclosed herein can be used to provide, to a user or other entity, visual information that can indicate active and/or inactive network connections, time until a network connection is available, identities of primary and/or secondary (or backup) network connections, application limitations and/or restrictions that apply at various times, combinations thereof, or the like. It should be understood that this example embodiment is illustrative, and therefore should not be construed as being limiting in any way.

In some embodiments, a user device may be connected to a local network and a wireless network at a first time and while at or near a first location. At this time, the user device may have access to a first group of mobile applications and/or associated features of the mobile applications. The user device may allow unrestricted access to the first group of features and/or functions of the mobile applications at the first time and while at or near a first location, with the first group corresponding to all mobile applications installed at the user device. As the user device moves (e.g., along a device path) away from the first location, the connectivity of the user device with the local network and the wireless network may change in terms of signal strength and the like. As such, embodiments of the concepts and technologies disclosed herein can enable the user device (e.g., via execution of the coverage management application) and/or the server computer (e.g., via execution of the coverage management service) to determine, based on the device data, the network data, the user database, and/or other information, that a connection with a direct-to-cell satellite network may be desirable and/or necessary.

For example, the user device and/or the server computer may determine that a connection with the local network and/or the wireless network will be unavailable and/or not strong enough to provide good QoS for the user device at a second time and second location. Thus, the concepts and technologies disclosed herein for determining network connections at a later time (e.g., a second time, a third time, or the like) can be used to determine if a connection to a direct-to-cell satellite network is possible and to communicate information relating to such a connection to a user device to improve user experience and/or for other reasons. Furthermore, the user device and/or the server computer can be configured to determine what limitations and/or restrictions should apply to the mobile applications at the second time and second location. For example, the user device can have access to a second group of mobile applications and/or features thereof at the second time and second location, with the second group of mobile applications being something less than all features and/or functionality of all mobile applications installed at the user device. It should be understood that this example embodiment is illustrative, and therefore should not be construed as being limiting in any way.

Additionally, it can be appreciated that embodiments of the concepts and technologies disclosed herein can be used to not only determine when a direct-to-cell satellite connection (e.g., provided by a satellite of the direct-to-cell satellite network) will be available, but also if and when that connection may become unavailable. Similarly, embodiments of the concepts and technologies disclosed herein can determine when some or all limitations or restrictions for the mobile applications will apply and/or when those limitations or restrictions will end. It can be appreciated that the user device may exit the coverage area associated with a satellite of the direct-to-cell satellite network at a third time. This exit may be due to movements of the user device, due to movements of satellites of the direct-to-cell satellite network relative to the earth (e.g., resulting in movement of the coverage area associated with a satellite of the direct-to-cell satellite network), and/or combinations of movements. As such, embodiments of the concepts and technologies disclosed herein can determine overlap of one or more coverage area associated with a satellite of the direct-to-cell satellite network and a geographic location of the user device over time and/or time ranges. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

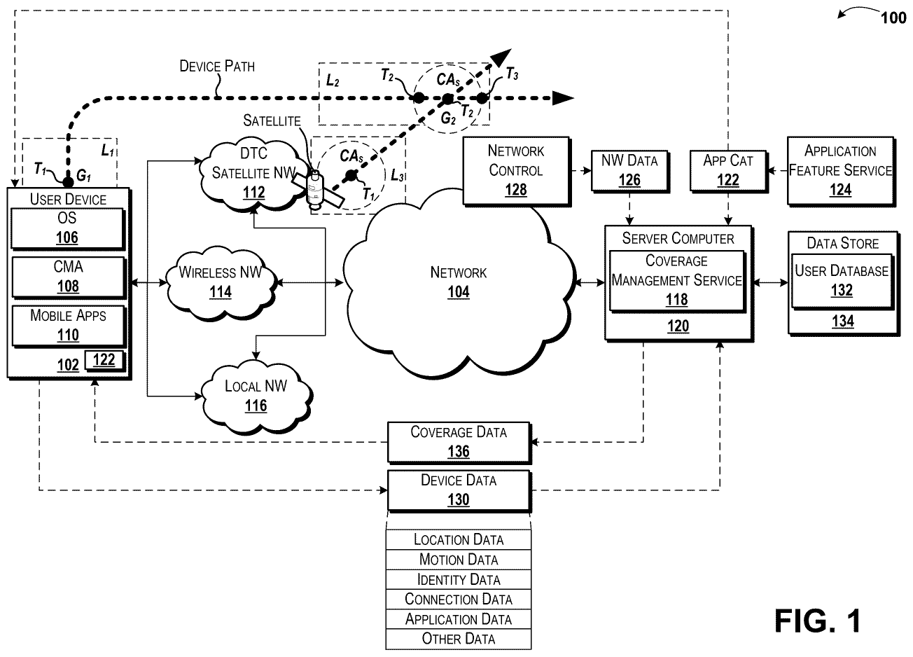

Referring now to FIG. 1, aspects of an operating environment 100 for various embodiments of the concepts and technologies disclosed herein for determining and using application limitations during direct-to-cell satellite coverage will be described, according to an illustrative embodiment. The operating environment 100 shown in FIG. 1 includes a user device 102. The user device 102 can operate in communication with and/or as part of a communications network (“network”) 104, though this is not necessarily the case in all embodiments. As will be further explained herein, the network 104 can be accessed by one or more other networks, portals, or the like. These and other aspects of the operating environment 100 will be explained in more detail hereinbelow after introducing the various components of the operating environment 100.

According to various embodiments, the functionality of the user device 102 may be provided by one or more mobile telephones or smartphones, laptop computers, tablet computers, vehicle computing systems, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can be configured to execute an operating system 106 and one or more application programs such as, for example, a coverage management application 108 (labeled “CMA” in FIG. 1) and one or more mobile applications 110 (labeled “Mobile Apps”) in FIG. 1). The operating system 106 can include a computer program that can control the operation of the user device 102. The coverage management application 108 can include an executable program that can be configured to execute on top of the operating system 106 to provide various functions as illustrated and described herein. The mobile applications 110 can include various native applications, web-based applications, hybrid applications (that run partially natively on the user device 102 and partially on a remote web server or other resource), combinations thereof, or the like. As is generally understood, the mobile applications 110 can include one or more features that can be provided on the user device 102 using local execution of locally-stored computer-executable instructions using locally-stored data and/or remotely-stored data, remote execution of remotely-stored computer executable instructions using locally-stored data and/or remotely-stored data, combinations thereof, or the like. Because the mobile applications 110 are generally understood, the basic concept of mobile applications 110 will not be further described here.

In various embodiments, the coverage management application 108 can be configured to detect and/or manage one or more network connections of the user device 102, to detect and/or manage access to one or more features and/or functionality of the mobile applications 110 based on network connections of the user device 102, combinations thereof, or the like. In particular, the user device 102 can be configured to connect to the network 104 directly and/or via one or more other networks or subnetworks such as, for example, a direct-to-cell satellite network (labelled “DTC satellite network” in FIG. 1) 112; a cellular and/or other wireless network (hereinafter referred to as a “wireless network”) 114; a local network 116 such as a WiFi network, a vehicle-to-vehicle network, or the like; other networks; combinations thereof; or the like. As is generally understood, capabilities of these networks, subnetworks, and/or other networking connections (e.g., the network 104, the direct-to-cell satellite network 112, the wireless network 114, the local network 116, etc.) can vary in general, based on time and/or proximity of the user device 102 to hardware associated with these connections, and/or based on other factors. According to various embodiments of the concepts and technologies disclosed herein, the coverage management application 108 can be configured to modify access at the user device 102 to the mobile applications 110 and/or to various features of the mobile applications 110, all of which may be based on active and/or expected network connections of the user device 102. These and other functions of the coverage management application 108 will be illustrated and described herein in more detail.

The user device 102 can connect to the local network 116, for example, via WiFi or the like, when located at, in, and/or near a WiFi-enabled location such as a home, business, vehicle, or the like. Thus, for example, the user device 102 may obtain access to the network 104 and/or other networks via a local network 116 at any particular time and/or location. The user device 102 also can be configured to access the wireless network 114 (e.g., a cellular network or the like) using cellular technology as is generally understood. For example, the user device 102 can be configured to communicate with the wireless network 114 to negotiate a connection and/or to be provisioned with cellular network connectivity using a cellular transceiver and/or other functionality as is generally understood. The user device 102 also can be configured to connect to the direct-to-cell satellite network 112 using its cellular transceiver and/or other hardware.

According to various embodiments of the concepts and technologies disclosed herein, the user device 102 can be configured to connect to one or more of the network 104, the direct-to-cell satellite network 112, the wireless network 114, and/or the local network 116 at any particular time at which the one or more networks are accessible to the user device 102. Thus, for example, a user device 102 located at a particular location may be configured to connect to the direct-to-cell satellite network 112, the wireless network 114, the local network 116, the network 104, and/or other networks simultaneously, in some embodiments. In some other embodiments, the user device 102 may not be connected to any network at a particular time. In yet other embodiments of the concepts and technologies disclosed herein, the user device 102 may be configured to connect to one or more of the direct-to-cell satellite network 112, the wireless network 114, the local network 116, the network 104, and/or other networks simultaneously. It should be understood that these example embodiments are illustrative, and therefore should not be construed as being limiting in any way.

According to various embodiments of the concepts and technologies disclosed herein, the coverage management application 108 can be configured to detect one or more connections between the user device 102 and the one or more networks 104, 112, 114, 116; to manage connections between the user device 102 and the one or more networks 104, 112, 114, 116; to communicate with other entities to project and/or predict connections available for the user device 102; to allow, block, limit, and/or modify access to the mobile applications 110 and/or to features or functionality of the mobile applications 110; to update a user interface at the user device 102 to reflect current and/or future network connections and/or to reflect current or expected limitations relating to the mobile applications 110; to perform other functions; combinations thereof; or the like. In various embodiments, for example, the coverage management application 108 can be configured to monitor one or more transceivers and/or other hardware of the user device 102 (e.g., a WiFi transceiver, a Bluetooth transceiver, a cellular transceiver, a physical connection port, or the like) to determine and/or identify one or more network connections currently available and/or active to the user device 102. Because this information can be obtained by the coverage management application 108 in additional and/or alternative manners (e.g., reporting mechanisms, or the like), it should be understood that this example embodiment is illustrative, and therefore should not be construed as being limiting in any way. The coverage management application 108 also can be configured to report the connections of the user device 102 to one or more other entities, as will be explained in more detail herein.

As noted above, the coverage management application 108 also can be configured to allow, block, limit, and/or modify access to the mobile applications 110 and/or to features or functionality of the mobile applications 110, as well as to communicate this and other information at the user device 102 and/or elsewhere. In particular, the coverage management application 108 can be configured to analyze the user device 102 to identify one or more mobile applications 110 installed at the user device 102. The coverage management application 108 also can be configured to analyze the mobile applications 110 (e.g., by analyzing computer-executable code associated with the mobile applications 110, by accessing an application library or catalog (hereinafter referred to as an “application catalog 122” and abbreviated/labeled “App Cat” in FIG. 1), which can include data that describes one or more of the mobile applications 110; by accessing a remote service such as an application feature service 124, which can host and/or provide the application catalog 122 to the user device 102 and/or other entities; combinations thereof, or the like) to identify one or more features and/or functionality associated with the mobile applications 110. Because the features and/or functionality associated with the mobile applications 110 can be determined in additional and/or alternative manners at the user device 102 and/or elsewhere as illustrated and described herein, it should be understood that these example embodiments are illustrative, and therefore should not be construed as being limiting in any way.

For example, the coverage management application 108 may analyze a mobile application 110 that includes functionality for sending text-based messages along with functionality for sending images, videos, audio, and the like. The coverage management application 108 can determine, based on the functionality and/or based on known information (e.g., from an application library, service or the like such as the application catalog 122 and/or the application feature service 124), what network connections can support one or more features and/or functionality of the mobile application 110. In the example embodiment above, the coverage management application 108 can determine, for example, a first bandwidth and/or connection speed needed to provide the sending and/or receipt of text-based messages, a second bandwidth and/or connection speed needed to provide the sending and/or receipt of images, a third bandwidth and/or connection speed needed to provide the sending and/or receipt of videos, a fourth bandwidth and/or connection speed needed to provide the sending and/or receipt of audio, combinations thereof, or the like. Thus, it can be appreciated that the coverage management application 108 can identify one or more mobile applications 110 and one or more features and/or functionality that may be used at various times and/or under various conditions including, but not limited to, what network connections exist for the user device 102 at any particular time. It should be understood that this example embodiment is illustrative, and therefore should not be construed as being limiting in any way.

The coverage management application 108 can also determine what (if any) limitations to impose for the applications and/or application features in some embodiments. Thus, for example, the coverage management application 108 may limit a mobile application 110 to local execution and/or access to local (e.g., on the user device 102) data in providing functionality associated with the mobile application 110 in some embodiments. In some other embodiments, the coverage management application 108 may disable and/or prevent access to the mobile application 110 when a network connection doesn't support full functionality associated with the mobile application 110. It should be understood that these example embodiments are illustrative, and therefore should not be construed as being limiting in any way.

Additionally, as will be illustrated and described herein in more detail, the coverage management application 108 can determine (and/or can obtain information from other entities) when a network connection is expected to change for the user device 102. Based on the time at which the network connection is expected to change, the coverage management application 108 can be configured to communicate, at the user device 102 and/or elsewhere, impending limitations for the mobile applications 110. In some embodiments, for example, the coverage management application 108 can be configured to modify one or more user interfaces at the user device 102 and/or to otherwise communicate this information to a user or other entity at the user device 102. These and other functions of the coverage management application 108 will be explained in more detail hereinbelow after introducing components of the operating environment 100. It should be understood that this example embodiment is illustrative, and therefore should not be construed as being limiting in any way.

As shown in FIG. 1, the user device 102 can be configured (e.g., via execution of the coverage management application 108) to communicate with a coverage management service 118. The functionality of the coverage management service 118 can be provided by an application, program, module, service, or the like, which can be hosted and/or executed by a computing device such as a server computer 120. In various embodiments, the functionality of the server computer 120 can be provided by an application server, a web server, or the like. The functionality of the server computer 120 may be provided by a single device, by two or more similar devices, and/or by two or more dissimilar devices (e.g., by a single server computer, by a cloud-based server computer, by one or more virtual resources, or the like). For purposes of describing the concepts and technologies disclosed herein, the server computer 120 is described herein as an application server. It should be understood that this example embodiment is illustrative, and therefore should not be construed as being limiting in any way.

The coverage management service 118 can be configured to identify network connections that are and/or will be available for the user device 102 at a current time and/or at one or more times in the future. In some embodiments, the coverage management service 118 also can be configured to determine one or more features and/or functions of the mobile applications 110 stored and/or executed at the user device 102 (e.g., by accessing an application library, service, or the like such as the application catalog 122, the application feature service 124, or the like). These and other determinations of the coverage management service 118 can be made based on information from the user device 102; information associated with the networks 104, 112, 114, 116; information obtained from application libraries or catalogs such as an application catalog 122, which as noted above can be stored at the user device 102 and/or can be hosted and/or provided to the coverage management service 118 by an application feature service 124 or other resource remote from the user device 102; information obtained from one or more services; and/or other information. It should be understood that this example embodiment is illustrative, and therefore should not be construed as being limiting in any way.

In various embodiments, the coverage management service 118 can be configured to obtain network data 126 from one or more network controllers and/or monitoring devices such as, for example, the network control 128. As illustrated and described herein, the network control 128 can include network monitoring functionality and network control functionality for monitoring, instantiating, controlling, and/or changing one or more network connections for the networks 104, 112, 114, 116. Thus, for example, the network control 128 can be configured to determine and/or maintain information indicating what network connections are active, available, inactive, and/or unavailable at one more times, locations, devices, or the like. It should be understood that this example embodiment is illustrative, and therefore should not be construed as being limiting in any way.

Based on the network data 126 (e.g., network topographies, network schedules, network load data, etc.), the coverage management service 118 can identify one or more devices or users (“users”) connected to one or more networks and/or network resources; networks and/or network resources that are or are not available at any particular time and/or location; combinations thereof; or the like. For example, as shown in FIG. 1, the user device 102 may not be stationary and may move from time to time. For example, if the user device 102 corresponds to an automobile, the automobile may drive along a path and may be located at a first location L₁ at a first time T₁ and may be located at a second location L₂ at a second time T₂. Similarly, if the user device 102 corresponds to a smartphone, the user device 102 may be located at the first location L₁ at the first time T₁ and may be located at the second location L₂ at the second time T₂. This and/or other information relating to one or more locations at which the user device 102 is located at one or more times can be collected by the network control 128 and reported to the coverage management service 118 as part of the network data 126. Thus, it can be appreciated that the network data 126 can include, inter alia, one or more data records that can include information identifying a particular device such as the user device 102, information identifying a location at which that device (e.g., the user device 102) is located at a particular time, information identifying a second location at which the device (e.g., the user device 102) is located at a second time, and the like. It should be understood that this example embodiment is illustrative, and therefore should not be construed as being limiting in any way.

Similarly, for example, a satellite coverage area CAₛ may move from a third location L₃ at the first time T₁ to the second location L₂ at the second time T₂. Thus, it can be appreciated with reference to FIG. 1 that the coverage area CAₛ associated with the direct-to-cell satellite network 112 can change over time in terms of location and the like. This and/or other information relating to one or more area of coverage associated with the one or more networks 104, 112, 114, 116 can be collected by the network control 128 and reported to the coverage management service 118 as part of the network data 126. Thus, it can be appreciated that the network data 126 can include, inter alia, one or more data records that can include information identifying a particular network connection, information identifying a location at which that network connection is available, information identifying a time at which that network connection is available at that location, and the like. It should be understood that this example embodiment is illustrative, and therefore should not be construed as being limiting in any way.

The coverage management service 118 also can be configured to obtain, from the user device 102 and/or other devices, device data 130. The device data 130 can include location data, motion data, identity data, connection data, application data, and/or other data for a particular device (e.g., the user device 102). The location data can identify, for example, a current or past geographical location of the user device 102. Thus, for example, the movement data and the location data can be used to determine, based on a current or past location and the movement data, a future expected location at some time. The motion data can describe, for example, a movement (current or expected) of the associated device such as the user device 102. For example, the movement data can reflect a movement vector including, at least, a heading and rate of travel. Because locations of the user device 102 and motion of the user device 102 can be used for additional and/or alternative purposes, it should be understood that this example embodiment is illustrative, and therefore should not be construed as being limiting in any way.

The identity data can identify the device itself (e.g., the user device 102) and/or a user thereof. Thus, the identity data can include, for example, a device identifier such as an International Mobile Subscriber Identity (“IMSI”), an International Mobile Equipment Identity (“IMEI”), a Permanent Equipment Identifier (“PEI”), a media access control identifier (“MAC ID”), a serial number, another device identifier, combinations thereof, or the like. The identity data also can identify a user of the device (e.g., the user device 102) such as a login, name, email address, unique identifier, combinations thereof, or the like. Because other information can identify devices (e.g., the user device 102) and/or users, it should be understood that these example embodiments are illustrative, and therefore should not be construed as being limiting in any way.

The connection data can identify, for a particular device such as the user device 102, one or more networks to which the device (e.g., the user device 102) is connected. In some embodiments, the connection data can be obtained by the coverage management service 118 from the network control 128 as illustrated and described herein, but devices such as the user device 102 can also be configured to provide this information to the coverage management service 118. In any case, it can be appreciated that the coverage management application 108 can be configured to collect and report the device data 130 to the coverage management service 118 in various embodiments. It should be understood that this example embodiment is illustrative, and therefore should not be construed as being limiting in any way.

The application data can identify, for example, one or more mobile applications 110 that are installed and/or otherwise accessible at the user device 102. The application data also can identify, for one or more of the mobile applications 110, features and/or functionality associated with the mobile applications 110. The application data also can identify, for the mobile applications 110 and/or features or functionality thereof, requirements (e.g., network requirements, bandwidth requirements, processing requirements, location requirements, and/or other requirements, or the like). The application data can be used, for example, to determine what mobile applications 110 and/or functionality thereof are to be allowed, blocked, restricted, or the like, depending on various network conditions and/or network connections. It should be understood that this example embodiment is illustrative, and therefore should not be construed as being limiting in any way.

The other data can include, for example, contextual information obtained from the user device 102 and/or applications or services used by and/or accessed by the user device 102; history information; or the like. For example, the other data can include calendaring data that can include expected time and location information, which can be used to project a location of the user device 102 at some time (e.g., an appointment time). The other data also can include, for example, routing data, which can be used to project a location (e.g., a destination or along a route) of the user device 102 at some time (e.g., at some point along the route, at an arrival time at the destination, or the like). It can be appreciated that the other data can include other information that can be used in some embodiments to project a location of the user device 102 at some time in the future and/or for other purposes. As such, it should be understood that these example embodiments are illustrative, and therefore should not be construed as being limiting in any way.

Based on the network data 126 and/or the device data 130, the coverage management service 118 can be configured to create, update, maintain, and/or modify a user database 132. The user database 132 can correspond to a log of one or more users, networks, or the like that connect to one or more of the networks 104, 112, 114, 116 and therefore can correspond, for example, to a subscriber log or file. According to various embodiments of the concepts and technologies disclosed herein, the user database 132 can be stored and/or hosted at a data store 134. The functionality of the data store 134 can be provided by one or more databases, server computers, data storage and/or host resources, other computing systems, and the like. In the illustrated embodiments, the data store 134 can be provided by a data server. It should be understood that this example embodiment is illustrative, and therefore should not be construed as being limiting in any way.

The user database 132 can include one or more records for one or more users such as, for example, the user device 102. A record for a user can include, for example, a current location, one or more active network connections, one or more available network connections, movement information (e.g., vectors, etc.), mobile applications 110 installed at the user device 102 and/or features thereof, other information, combinations thereof, or the like. The user database 132 also can include, for example, network records that can indicate locations associated with the network (e.g., permanent geographic boundaries for fixed networks, temporary geographic boundaries and associated time constraints for non-stationary networks such as some direct-to-cell satellite network 112 (e.g., geographic boundaries at one or more times), or other locations associated with networks such as buildings, offices, homes, or the like), network capabilities, network permissions, combinations thereof, or the like.

These network-specific and/or user-specific records can be accessed by the coverage management service 118 to identify available networks at any particular time (past, present, or future) and/or at any particular geographic location, to identify network connections available to a particular device (e.g., the user device 102) at any time or location, to identify mobile applications 110 and/or features thereof installed and/or used by the user device 102, to identify network capabilities for the user device 102 at any time or location, combinations thereof, or the like. According to some embodiments of the concepts and technologies disclosed herein, the user device 102 can determine and implement limits for the mobile applications 110 based on the network connection information obtained from the coverage management service 118. Thus, it should be understood that the example embodiment in which the coverage management service 118 determines what mobile applications 110 are installed at the user device 102 and what limitations are to be implemented at the user device 102 is illustrative and should not be construed as being limiting in any way.

According to various embodiments of the concepts and technologies disclosed herein, the coverage management service 118 can be configured to determine, for a device such as the user device 102, one or more network connections and/or network coverage that is or will be available to the user device 102 at some time. Thus, it can be appreciated that the coverage management service 118 can be configured to predict or project, based on the user database 132, one or more network connections and/or network coverage that is or will be available to a device such as the user device 102 at some present or future time. This information can be packaged by the coverage management service 118 as coverage data 136, and the coverage data 136 can be provided to one or more devices (e.g., the user device 102) at some time. As will be more clearly understood below, the coverage management application 108 at a device such as the user device 102 can be configured to generate one or more user interfaces and/or user interface elements based on the coverage data 136. The user interfaces and/or user interface elements can be presented at the user device 102 to communicate network availability to a user of the user device 102. It should be understood that this example embodiment is illustrative, and therefore should not be construed as being limiting in any way.

In practice, a user device 102 can execute a coverage management application 108 or other application to determine (or obtain information identifying) a geographic location of the user device 102 and movement of the user device 102, to detect when network connections associated with the user device 102 are expected to change, and possible connection limitations associated with the network connections. Based on the changes to network connections, the user device 102 can further execute the coverage management application 108 to detect mobile applications 110 installed at the user device 102, features and/or functionality of the mobile applications 110 that will be limited or restricted based on the network connection changes, and times associated with those limitations or restrictions such as start times, durations, end times, and the like.

In various embodiments, the geographic location of the user device 102 can be determined using a location device such as a GPS receiver or other location determination system or device and/or the user device 102 may receive information identifying its geographic location from other devices or entities such as location servers, network devices, or the like. The user device 102 also can be configured to determine movements and/or motion of the user device 102 by accessing a motion processor, sensors, and/or devices to determine motion, orientation, and/or movements of the user device 102. The user device 102 can also be configured to identify and/or determine one or more network connections available, unavailable, active, and/or inactive for the user device 102. The user device 102 can generate device data 130 that can represent the location of the user device 102, movements of the user device 102, and/or network connections for the user device 102 as determined by the user device 102. The user device 102 can also add, to the device data 130, identity data that identifies the user device 102 and/or a user or account associated with the user device 102, contextual information that can describe future locations and/or times associated with those locations (e.g., from routing software, calendar applications, or the like), and/or other data. The user device 102 can provide the device data 130 to a recipient such as the coverage management service 118 and/or the server computer 120 that hosts and/or executes the coverage management service 118. The coverage management service 118 can use the device data 130 to generate and/or update the user database 132, to create and/or update coverage data 136, and/or for other purposes.

A server computer 120 can host and/or execute the coverage management service 118. The server computer 120 can obtain the device data 130 from the user device 102 and/or other device or entity. The server computer 120 can determine, based on the device data 130, one or more locations of the device (e.g., the user device 102) at one or more future times. In some embodiments, the server computer 120 can determine the expected location by analyzing location data and motion data. In some embodiments, for example, the motion data can include a vector that can define a heading and speed of the user device 102. Thus, the server computer 120 can predict the location of the user device 102 by applying the vector to the location of the user device 102 over some time to predict, project, and/or extrapolate the location of the user device 102 at one or more times in the future. In some other embodiments, the server computer 120 can determine an expected location for the user device 102 at some time in the future by accessing contextual information such as, for example, routing information (e.g., the user device 102 may be used to navigate to a destination, so the destination can be projected to be the future location of the user device 102 at a time corresponding to the arrival time, for example), calendar information (e.g., a location of an appointment at an appointment time can correspond to an expected location at a particular time, etc.), or the like. Thus, the server computer 120 can determine, in multiple manners, one or more locations of the user device 102 at which the user device 102 is expected to be located at one or more times in the future.

The server computer 120 can use the determined locations and times to identify network connections that are expected to be available at the times and locations. The server computer 120 may determine, for example, that a coverage area CAₛ associated with a particular satellite of a direct-to-cell satellite network 112 is projected or predicted to be at a first location L₁ at a first time T₁ and at a second location L₂ at a second time T₂. The server computer 120 also can determine one or more other network connections that may be expected to be available at the locations and times identified. The server computer 120 can generate coverage data 136 that can identify network connections available at various locations over various times. The server computer 120 can send the coverage data 136 to the user device 102 for use in generating one or more user interfaces.

When generating the coverage data 136, the server computer 120 can also be configured to determine time, location, and/or other limitations for the identified network connections. Thus, for example, the server computer 120 can determine, for a satellite connection at a particular location, any limits in terms of time, location, or the like. These limits can be added to the coverage data 136. Also, the server computer 120 can be configured to determine, in some embodiments, one or more mobile applications 110 installed at the user device 102 and/or functionality of those mobile applications 110. In some embodiments, the server computer 120 can be configured to access an application feature service 124 and/or an application catalog 122 to determine features of the mobile applications 110, and this information can be used to determine one or more application restrictions or limitations that are to exist when the network connections change in some instances. In various embodiments, the identification of the mobile applications 110, the features and/or functions thereof, and any limitations that will apply when the user device 102 is connected to some network connections can be determined by the user device 102 (e.g., by executing the coverage management application 108) without any action by the server computer 120. In any event, the server computer 120 can create the coverage data 136 (with or without application limitations information) and provide the coverage data 136 to the user device 102 for use in generating user interfaces and/or user interface elements at the user device 102.

The user device 102 can obtain the coverage data 136 and output the coverage data 136 at the device (e.g., the user device 102). The user device 102 can be configured to determine what application limitations or restrictions may exist when the network connection changes, and generate one or more user interfaces and/or user interface elements based on the coverage data 136 and the application information. Thus, for example, the user device 102 can be configured to display one or more indicators that indicate active and/or available network connections, inactive and/or unavailable network connections, network connection status information, a time until a network connection will be available and the like, as well as application limitations or restrictions that may be imposed when the network connection changes. Thus, embodiments of the concepts and technologies disclosed herein can be used to provide, to a user or other entity, visual information that can indicate active and/or inactive network connections, time until a network connection is available, identities of primary and/or secondary (or backup) network connections, application limitations and/or restrictions that apply at various times, combinations thereof, or the like. It should be understood that this example embodiment is illustrative, and therefore should not be construed as being limiting in any way.

It can be appreciated with reference to FIG. 1 that a user device 102 may be connected to a local network 116 and a wireless network 114 at a first time T₁ and while at or near a first location L₁. At this time, the user device 102 may have access to a first group G₁ of mobile applications 110 and/or associated features of the mobile applications 110. In the illustrated embodiment shown in FIG. 1, the user device 102 may allow unrestricted access to the first group G₁ at the first time T₁ and while at or near a first location L₁, with the first group G₁ corresponding to all mobile applications 110 installed at the user device 102. As the user device 102 moves (e.g., along a device path) away from the first location L₁, the connectivity of the user device 102 with the local network 116 and the wireless network 114 may change in terms of signal strength and the like. As such, embodiments of the concepts and technologies disclosed herein can enable the user device 102 (e.g., via execution of the coverage management application 108) and/or the server computer 120 (e.g., via execution of the coverage management service 118) to determine, based on the device data 130, the network data 126, the user database 132, and/or other information, that a connection with a direct-to-cell satellite network 112 may be desirable and/or necessary.

For example, the user device 102 and/or the server computer 120 may determine that a connection with the local network 116 and/or the wireless network 114 will be unavailable and/or not strong enough to provide good quality of service (“QoS”) for the user device 102 at a second time T₂ and second location L₂. Thus, the concepts and technologies disclosed herein for determining network connections at a later time (e.g., a second time T₂, a third time T₃, or the like) can be used to determine if a connection to a direct-to-cell satellite network 112 is possible and to communicate information relating to such a connection to a user device 102 to improve user experience and/or for other reasons. Furthermore, the user device 102 and/or the server computer 120 can be configured to determine what limitations and/or restrictions should apply to the mobile applications 110 at the second time T₂ and second location L₂. As shown in FIG. 1, the user device 102 can have access to a second group G₂ of mobile applications 110 and/or features thereof at the second time T₂ and second location L₂, with the second group G₂ of mobile applications 110 being something less than all features and/or functionality of all mobile applications 110 installed at the user device 102. It should be understood that this example embodiment is illustrative, and therefore should not be construed as being limiting in any way.

Additionally, it can be appreciated that embodiments of the concepts and technologies disclosed herein can be used to not only determine when a direct-to-cell satellite connection (e.g., provided by a satellite of the direct-to-cell satellite network 112) will be available, but also if and when that connection may become unavailable. Similarly, embodiments of the concepts and technologies disclosed herein can determine when some or all limitations or restrictions for the mobile applications 110 will apply and/or when those limitations or restrictions will end. With reference to the device path of the user device 102 illustrated in FIG. 1, it can be appreciated that the user device 102 may exit the coverage area CAₛ associated with a satellite of the direct-to-cell satellite network 112 at a third time T₃. This exit may be due to movements of the user device 102 in some embodiments such as that shown in FIG. 1, due to movements of satellites of the direct-to-cell satellite network 112 relative to the earth (e.g., resulting in movement of the coverage area CAₛ associated with a satellite of the direct-to-cell satellite network 112), and/or combinations of movements. As such, embodiments of the concepts and technologies disclosed herein can determine overlap of one or more coverage area CAₛ associated with a satellite of the direct-to-cell satellite network 112 and a geographic location of the user device 102 over time and/or time ranges. It should be understood that this example embodiment is illustrative, and therefore should not be construed as being limiting in any way.

FIG. 1 illustrates one user device 102, one network 104, one direct-to-cell satellite network 112 having one satellite, one wireless network 114, one local network 116, one server computer 120, one application feature service 124, one network control 128, and one data store 134. It should be understood, however, that various implementations of the operating environment 100 can include one or more than one user device 102; one or more than one network 104; one or more than one direct-to-cell satellite network 112 (one or more of which may have one or more than one satellite); one or more than one wireless network 114; one or more than one local network 116; one or more than one server computer 120; zero, one, or more than one application feature service 124; one or more than one network control 128; and/or zero, one, or more than one data store 134. As such, the illustrated embodiment should be understood as being illustrative, and should not be construed as being limiting in any way.

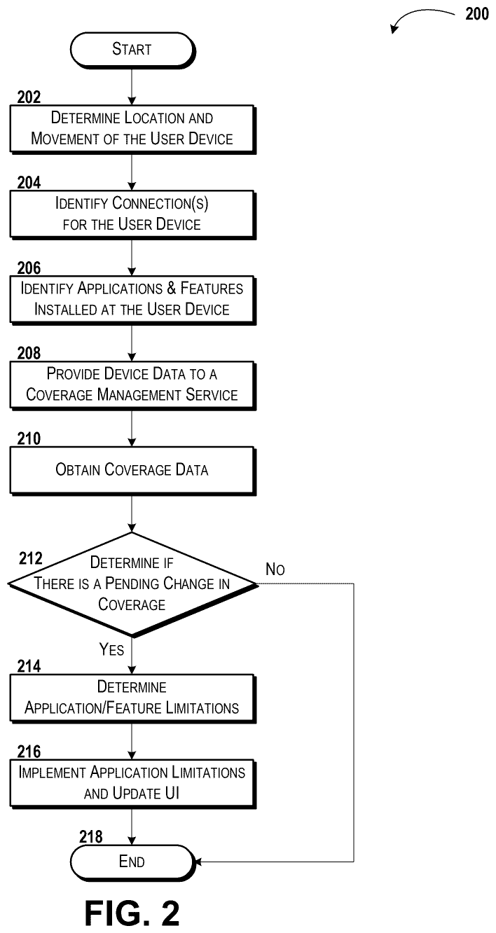

Turning now to FIG. 2, aspects of a method 200 for obtaining information for limiting applications during direct-to-cell satellite coverage will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 and/or the server computer 120 to perform one or more operations and/or causing the processor to direct other components of the computing system or device to perform one or more of the operations.

For purposes of illustrating and describing the concepts of the present disclosure, the method 200 is described herein as being performed by the user device 102 via execution of one or more software modules such as, for example, the coverage management application 108. It should be understood that additional and/or alternative devices and/or network nodes can provide the functionality described herein via execution of one or more modules, applications, and/or other software including, but not limited to, the coverage management application 108. Thus, the illustrated embodiments are illustrative, and should not be viewed as being limiting in any way.

The method 200 begins at operation 202. At operation 202, the user device 102 can determine a location and movement of a device such as the user device 102. According to various embodiments of the concepts and technologies disclosed herein, the user device 102 can be configured to monitor (e.g., via execution of the coverage management application 108 and/or other applications) activity of the user device 102 to determine, at any particular time, a location (e.g., a geographic location) of the user device 102. In various embodiments, the location of the user device 102 can be determined by the user device 102 using a location device such as a GPS receiver or other location determination system or device. In some other embodiments, the user device 102 may receive its location (e.g., its geographic location) from other devices or entities such as location servers, network devices, or the like. Thus, it can be appreciated that a geographic location of the user device 102 can be determined using GPS receivers, network triangulation or other network determinations, location beacons (e.g., Bluetooth beacons or the like), and/or other on-board or off-board devices or entities. It should be understood that these example embodiments are illustrative, and therefore should not be construed as being limiting in any way.

The user device 102 also can be configured (e.g., via execution of the coverage management application 108 and/or other applications) to determine motion and/or movements of the user device 102. In some embodiments, for example, the user device 102 can include a motion processor and/or one or more sensors or devices to determine motion, orientation, and/or movements of the user device 102. In some embodiments of the concepts and technologies disclosed herein, the user device 102 can include a sensor array that can include an accelerometer, a magnetometer, a gyroscope, and/or other sensors that can determine movements of the user device 102 in terms of speed, direction, acceleration, and the like. It should be understood that this example embodiment is illustrative, and therefore should not be construed as being limiting in any way. Regardless of how location and movements are determined, embodiments of the concepts and technologies disclosed herein include determining a location of the user device 102 and a movement or motion vector associated with the user device 102. These and other data can be used, for example by the coverage management service 118 as will be illustrated and described in more detail below, to determine one or more predicted or projected geographic locations of the user device 102 at some point(s) of time in the future. At any rate, the user device 102 can collect data that indicates a geographic location of the user device 102 and movements or motion of the user device 102. It should be understood that this example embodiment is illustrative, and therefore should not be construed as being limiting in any way.

From operation 202, the method 200 can proceed to operation 204. At operation 204, the user device 102 can determine one or more connections for a device such as the user device 102. According to various embodiments, the user device 102 can determine (e.g., via execution of the coverage management application 108 and/or other applications) one or more active, inactive, available, and/or unavailable network connections for the user device 102. According to various embodiments, the user device 102 may identify one or more connections via the operating system 106 and/or other applications executing on the user device 102, and this information can be passed to the coverage management application 108 and/or other applications. According to various embodiments of the concepts and technologies disclosed herein, the user device 102 can determine, in operation 204, one or more active network connections, zero, one, or more than one inactive network connection, zero, one, or more than one primary network connection, zero, one, or more than one secondary network connection, zero, one, or more than one available network connection, zero, one, or more than one unavailable network connections, or the like.

From operation 204, the method 200 can proceed to operation 206. At operation 206, the user device 102 can identify mobile applications 110 that are installed at the user device 102. In operation 206, the user device 102 also can identify one or more features and/or functions of each of the one or more mobile applications 110 that are installed at the user device 102. According to various embodiments of the concepts and technologies disclosed herein, the user device 102 can be configured to determine the one or more features and/or functions of the one or more mobile applications 110 by, for example, analyzing the mobile applications 110 and/or software code thereof to determine the features and/or functions, by accessing an application catalog 122 (e.g., stored at the user device 102 and/or the application feature service 124), and/or by receiving information from additional and/or alternative sources. In operation 206, the user device 102 can determine, for example, what functions and/or features of the mobile applications 110 may use a network connection, bandwidths and/or speeds and/or latencies associated with ideal network connections for the mobile applications 110 (e.g., features and/or functions thereof), and the like. Thus, operation 206 can include the user device 102 determining what data communication capabilities may be used and/or may be ideal. Because additional functions and/or features of the one or more mobile applications 110 can be determined for additional and/or alternative reasons, it should be understood that this example embodiment is illustrative, and therefore should not be construed as being limiting in any way.

From operation 206, the method 200 can proceed to operation 208. At operation 208, the user device 102 can provide device data 130 to a coverage management service 118. Although not separately illustrated in FIG. 2, it can be appreciated that the user device 102 can be configured to create the device data 130 as part of operation 206 and/or as part of operations 202-206. In particular, the user device 102 can be configured to add data identifying the location of the user device 102, data identifying one or more motions or movements of the user device 102, and/or data identifying one or more network connections to a data file that can correspond to the device data 130 illustrated and described herein. The user device 102 can also be configured to add, to the device data 130, identity data that identifies the user device 102 and/or a user or account associated with the user device 102, and/or other data. In some embodiments, the user device 102 also can be configured to add, to the device data 130, application data that can identify one or more mobile applications 110 installed at the user device 102 and/or features or functions thereof. The user device 102 can be configured to provide the device data 130 to a recipient such as the coverage management service 118 and/or the server computer 120 that hosts and/or executes the coverage management service 118. As explained herein, the coverage management service 118 can use the device data 130 to generate the user database 132, to look up and/or determine limitations to implement at the user device 102 for some changes to network changes, to create coverage data 136, and/or for other purposes. It should be understood that this example embodiment is illustrative, and therefore should not be construed as being limiting in any way.

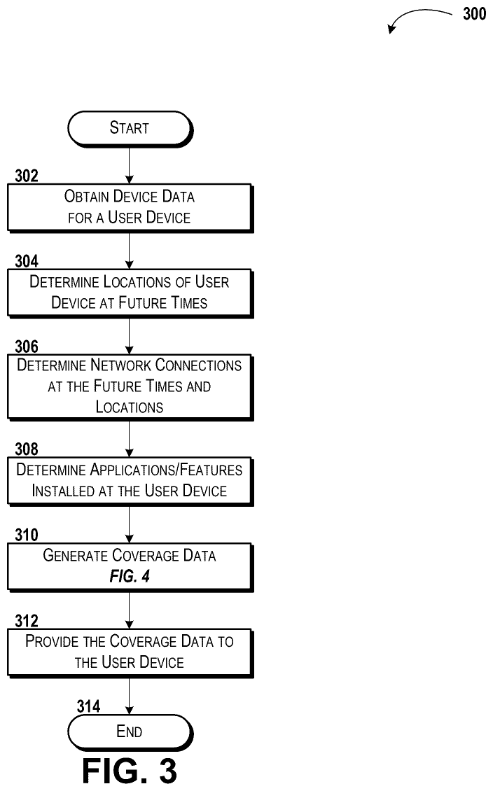

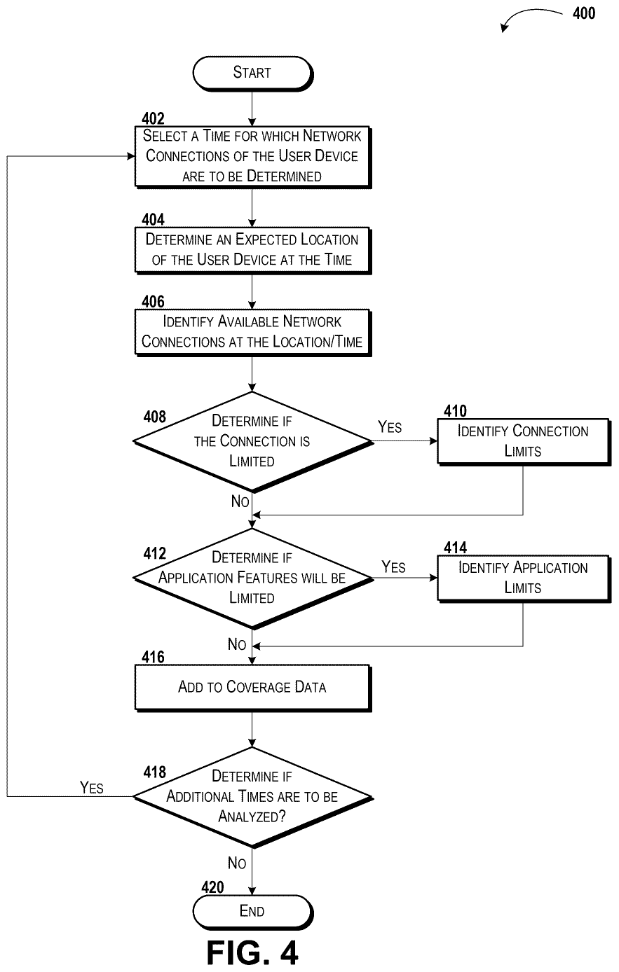

From operation 208, the method 200 can proceed to operation 210. At operation 210, a device such as the user device 102 can obtain coverage data 136. The coverage data 136 can correspond to a data file that can include one or more records or entries. According to various embodiments of the concepts and technologies disclosed herein, each of the records or entries can identify zero, one, or more than one network connection that is or are expected to be available for the user device 102 at a location at which the user device 102 is at and/or is expected to be at during one or more times or time ranges. Thus, for example, a first record can indicate that when the user device 102 is located at a particular location and/or at a particular time, that one or more network connections are expected to be available. It can be appreciated that these determinations can be made by the coverage management service 118 based on the device data 130 and/or the network data 126. These determinations of the coverage management service 118 will be illustrated and described in more detail below with reference to FIGS. 3-4. At any rate, the user device 102 can receive the coverage data 136, which can indicate these available network connections at one or more times.

In some embodiments of the concepts and technologies disclosed herein, the coverage data 136 also can include data that identifies one or more limitations that are to be implemented at the user device 102 for one or more mobile applications 110 and/or features or functions thereof based on any expected changes to network connections associated with the user device 102. In other embodiments, as is the case in the embodiment illustrated in FIG. 2, the user device 102 can determine and implement limitations on the mobile applications 110 and/or features or functions thereof based on the coverage data 136 and knowledge of the mobile applications 110. Because limitations for the mobile applications 110 and/or features or functions thereof can be determined and/or implemented in additional and/or alternative manners, it should be understood that these example embodiments are illustrative, and therefore should not be construed as being limiting in any way.

From operation 210, the method 200 can proceed to operation 212. At operation 212, the user device 102 can determine if there is a pending change in coverage for the user device 102 (e.g., if there is any expected or upcoming change to one or more network connections associated with the user device 102). It can be appreciated that the determination of operation 212 can be made by the user device 102 by analyzing the coverage data 136 obtained operation 210 in various embodiments. Thus, the user device 102 can determine if a network connection is changing (e.g., if a network connection is ending, if a network connection is being added, if a network connection is being changed, combinations thereof, or the like) at some period of time or point in time. As explained herein, the user device 102 can detect such a pending change in coverage (or network connection) by analyzing the coverage data 136. Thus, it can be appreciated that the coverage data 136 may include data that indicates a changing network connection, a time at which the network connection is changing, a time period for which the network connection will be available, combinations thereof, or the like. It should be understood that this example embodiment is illustrative, and therefore should not be construed as being limiting in any way.

If the user device 102 determines, in operation 212, that there is a pending change in coverage for the user device 102, the method 200 can proceed to operation 214. At operation 214, the user device 102 can determine one or more application limitations for one or more mobile applications 110 at the user device 102 and/or can determine one or more features of the one or more mobile applications 110 at the user device 102. Based on the pending coverage change, the user device 102 can determine what mobile applications 110 should be allowed or enabled, blocked or disabled, restricted, or the like. According to various embodiments of the concepts and technologies disclosed herein, the user device 102 can determine, based on the one or more features of the mobile applications 110 installed at the user device 102, how the coverage change will affect the mobile applications 110. For example, if the user device 102 is switching from a WiFi connection to a satellite-based connection, data connection speed and bandwidth capabilities may decrease substantially and certain data-rich features may be disabled at the user device 102 while connected to the satellite-based connection. It should be understood that this example embodiment is illustrative, and therefore should not be construed as being limiting in any way.

Thus, operation 214 can include the user device 102 identifying the mobile applications 110 and determining what should be allowed or disallowed. This determination can be based on analysis of the mobile applications 110 by the user device 102. This analysis can be based, in some embodiments, on data such as the application catalog 122, which can be stored at the user device 102, obtained from the application feature service 124, and/or elsewhere. In some other embodiments, the analysis of operation 214 can be performed by the user device 102 based on communications with the coverage management service 118, which can provide information about the mobile applications 110 in some embodiments. In some embodiments, a user or other entity may specify for various mobile applications, what features of the applications and/or what applications will be allowed and/or disallowed based on network connection parameters, settings that can be configured in some instances using a preferences screen or the like. Thus, operation 214 can include the user device 102 identifying the mobile applications 110, and determining, based on analysis at the user device 102 and/or elsewhere, one or more features of the mobile applications 110 that should be allowed or disallowed or otherwise restricted (e.g., restricted to analysis locally on local data only, etc.). It should be understood that this example embodiment is illustrative, and therefore should not be construed as being limiting in any way.

In operation 214, the user device 102 also can determine, based on the coverage data 136 and knowledge of the mobile applications 110 used at the user device 102, a timeframe for any application limitations and/or restrictions. The timeframes can include a start time for one or more of the application restrictions and/or limitations, a duration for one or more of the application restrictions and/or limitations, an end time for one or more of the application restrictions and/or limitations, combinations thereof, or the like. Thus, the user device 102 can determine, for example, a start time at which one or more application limitations and/or restrictions may start, how long the one or more application limitations and/or restrictions will last after the start time, when the one or more application limitations and/or restrictions will end, combinations thereof, or the like.

From operation 214, the method 200 can proceed to operation 216. At operation 216, the user device 102 can implement the application and/or feature limitations determined for the mobile applications 110 in operation 214 and update a user interface at the user device 102. The user device 102 can apply the limitations determined in operation 214 to the mobile applications 110. Thus, for example, if the user device 102 determines in operation 214 that a particular mobile application 110 is to be disabled, the user device 102 can disable the particular mobile application 110 in operation 216. Similarly, if the user device 102 determines in operation 214 that a particular feature of a particular mobile application 110 is to be disabled or otherwise restricted, the user device 102 can disable the particular feature of the particular mobile application 110 in operation 216. Of course, the user device 102 can apply time limits to any disabling of a mobile application and/or feature thereof (e.g., based on the network connections that are changing and/or any associated time period, etc.). It should be understood that this example embodiment is illustrative, and therefore should not be construed as being limiting in any way.

In operation 216, the user device 102 also can update one or more user interfaces. In some embodiments, the user device 102 can be configured to generate one or more user interfaces and/or user interface elements based on the coverage data 136, thereby updating the user interface to reflect the current and/or future network connections available at the user device 102. Thus, for example, the user device 102 can be configured to display one or more indicators that indicate active and/or available network connections, inactive and/or unavailable network connections, network connections expected to be available at some time in the future, network connection status information, and the like. It should be understood that this example embodiment is illustrative, and therefore should not be construed as being limiting in any way.

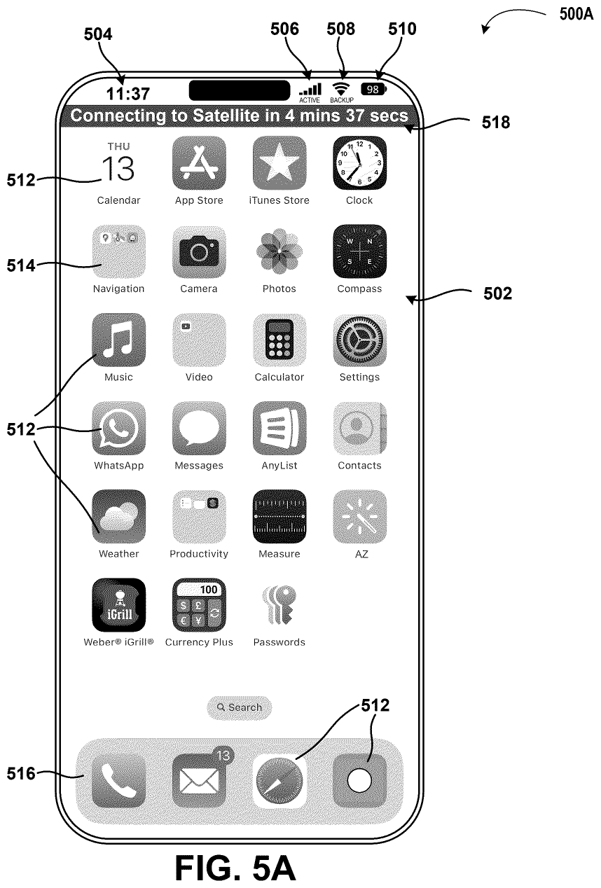

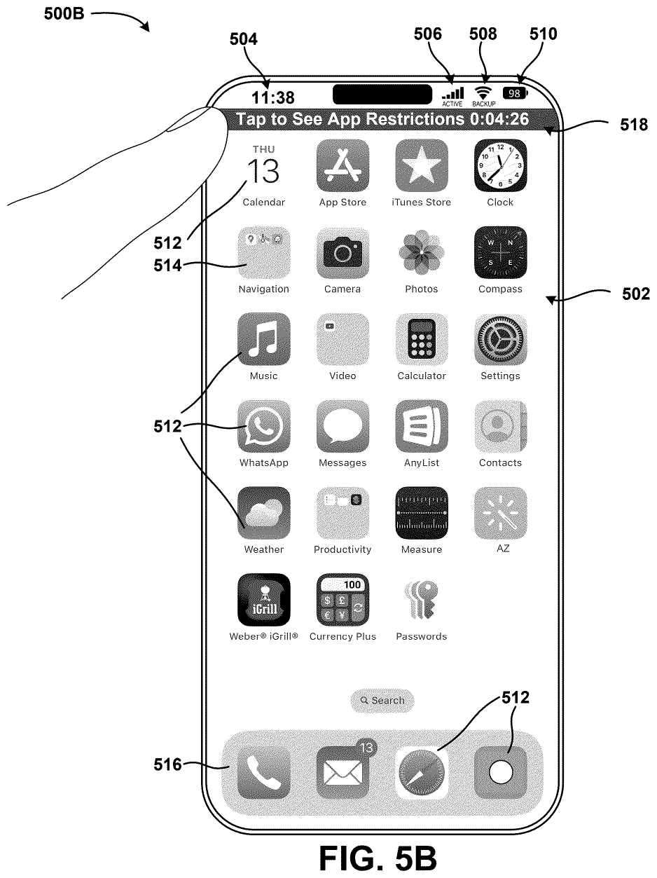

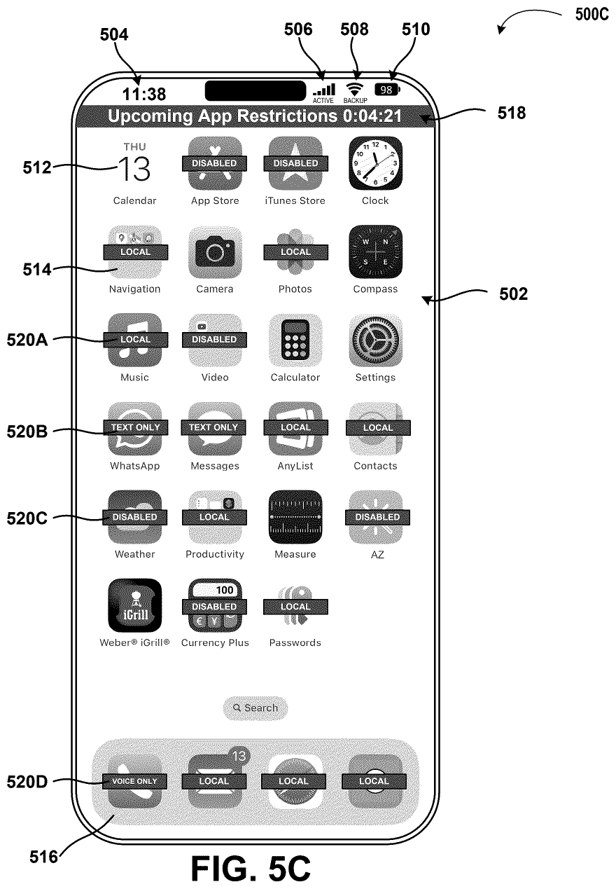

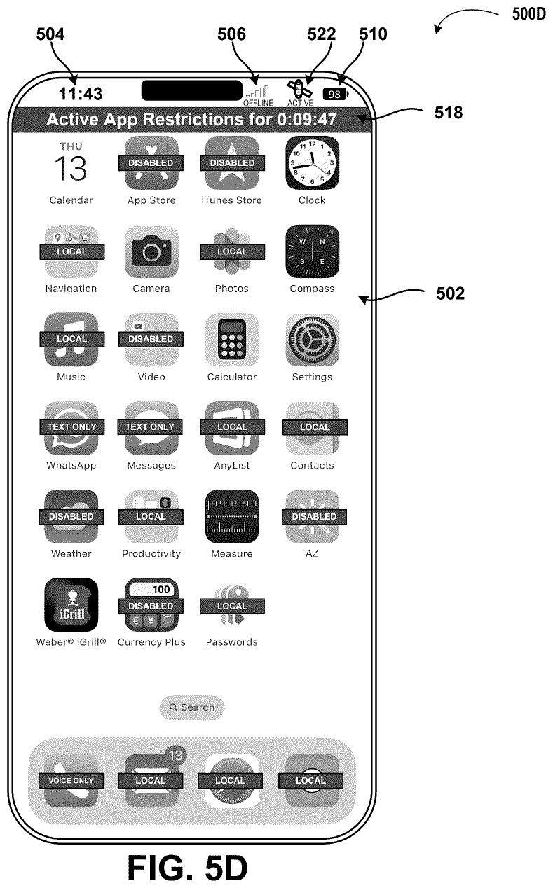

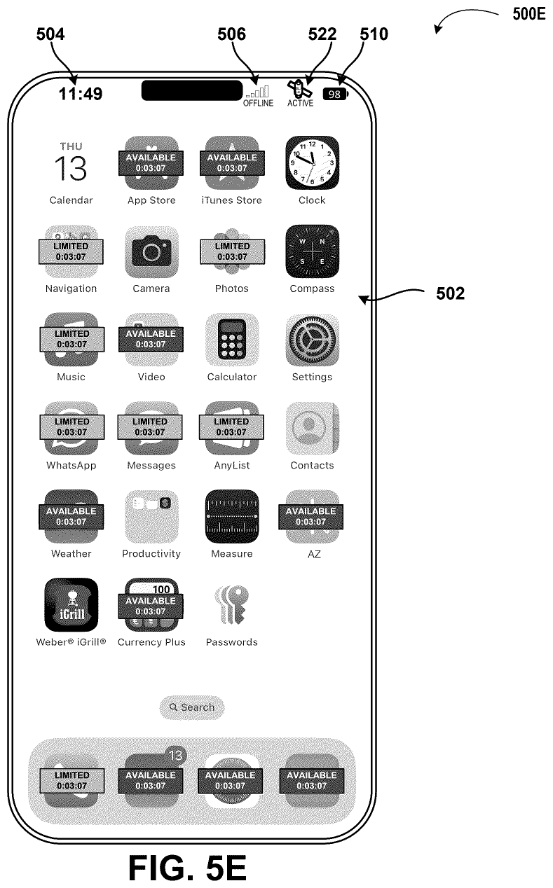

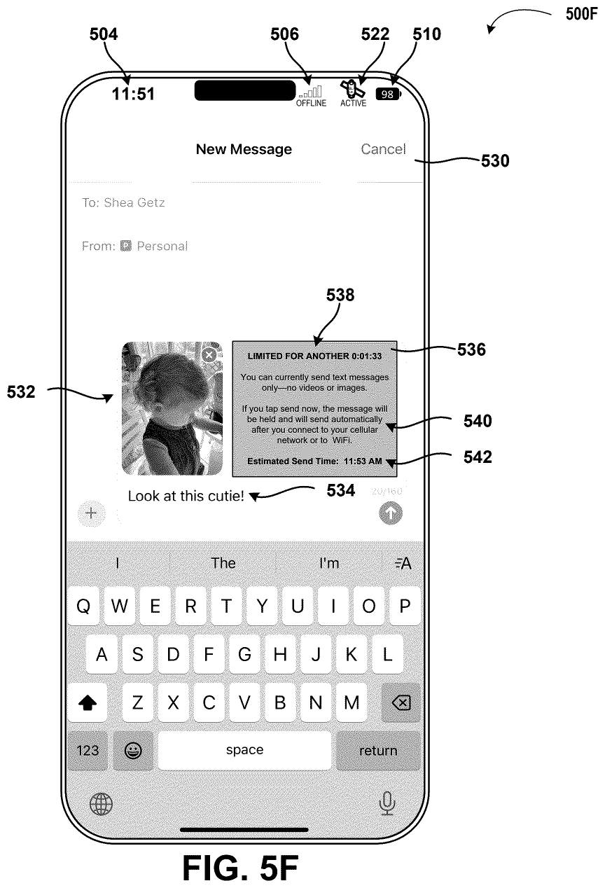

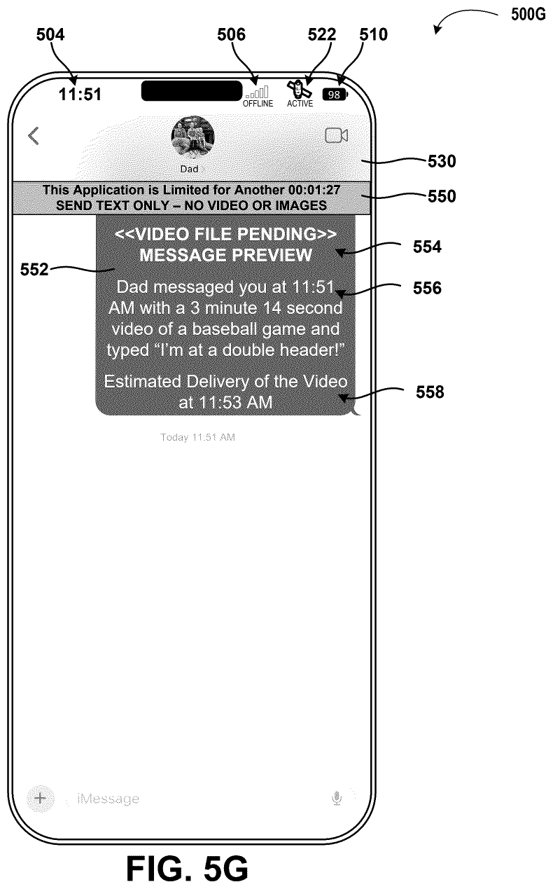

The user device 102 also can be configured to update a user interface to show the limitations placed on the mobile applications 110 and/or features thereof. For example, the user device 102 can update an icon or other representation associated with a mobile application 110 to indicate that the mobile application 110 is blocked, allowed, restricted, or the like. These and/or other user interface changes can be made to inform users regarding pending or activate application limitations. Some example user interfaces will be illustrated and described below with reference to FIGS. 5A-5G. As such, the above examples are illustrative, and therefore should not be construed as being limiting in any way.

From operation 216, the method 200 can proceed to operation 218. The method 200 also can proceed to operation 218 from operation 212 if the user device 102 determines, in operation 212, that there is not a pending change in coverage for the user device 102. The method 200 can end at operation 218.

Turning now to FIG. 3, aspects of a method 300 for providing information for limiting applications during direct-to-cell satellite coverage will be described in detail, according to an illustrative embodiment. For purposes of illustrating and describing the concepts of the present disclosure, the method 300 is described herein as being performed by the server computer 120 via execution of one or more software modules such as, for example, the coverage management service 118. It should be understood that additional and/or alternative devices and/or network nodes can provide the functionality described herein via execution of one or more modules, applications, and/or other software including, but not limited to, the coverage management service 118. Thus, the illustrated embodiments are illustrative, and should not be viewed as being limiting in any way.

The method 300 begins at operation 302. At operation 302, the server computer 120 can obtain device data 130 for a device such as the user device 102. As explained herein, the device data 130 can include, for example, location data that can identify a location (e.g., a geographic location) of the user device 102 at a particular time; motion data that can identify one or more motions or movements of the user device 102 at a particular time; identity data that can identify the user device 102 and/or a user or account associated with the user device 102; connection data that can identify one or more network connections that are available to the user device 102, unavailable to the user device 102, active for the user device 102, inactive for the user device 102; and/or other data associated with the user device 102. According to various embodiments of the concepts and technologies disclosed herein, the device data 130 can be released by the user device 102 once and/or multiple times based on time intervals, when changes are detected, when requested by the coverage management service 118 and/or other entities, and/or at other times. It should be understood that this example embodiment is illustrative, and therefore should not be construed as being limiting in any way.

From operation 302, the method 300 can proceed to operation 304. At operation 304, the server computer 120 can determine one or more locations of the device (e.g., the user device 102) at one or more future times. In some embodiments, the server computer 120 can determine the one or more locations based on the location data and the motion data of the device data 130. In particular, the server computer 120 can determine, for the user device 102, one or more projected or predicted locations of the user device 102. For example, by knowing the geographic location of the user device 102 at a first time (e.g., from the location data included in the device data 130) and movements of the user device 102 (e.g., from the motion data included in the device data 130), the server computer 120 can predict or project a geographic location of the user device 102 at some time in the future.

In some embodiments, for example, the motion data can include a vector that can define a heading and speed of the user device 102. Thus, the server computer 120 can predict the location of the user device 102 by applying the vector to the location of the user device 102 over some time to predict, project, and/or extrapolate the location of the user device 102 at one or more times in the future. It can be appreciated that the prediction may be based on constant movements of the user device 102, and therefore the server computer 120 can be configured to obtain updated device data 130 at intervals, upon changes, and/or at other times to update the projected or predicted location(s) of the user device 102. It should be understood that this example embodiment is illustrative, and therefore should not be construed as being limiting in any way.

In yet other embodiments, the server computer 120 can determine an expected location for the user device 102 at some time in the future by accessing contextual information such as, for example, routing information (e.g., the user device 102 may be used to navigate to a destination, so the destination can be projected to be the future location of the user device 102 at a time corresponding to the arrival time, for example), calendar information (e.g., a location of an appointment at an appointment time can correspond to an expected location at a particular time, etc.), or the like.

Regardless of how often the calculations are updated, the server computer 120 can predict one or more future locations of the user device 102 in operation 304 and times associated with the expected presence of the user device 102 at those locations. For example, the server computer 120 may determine that the user device 102 is projected or predicted to be at a first location L₁ at a first time T₁ and at a second location L₂ at a second time T₂. These projections and/or predictions can be added to a data file and/or data log by the server computer 120. It should be understood that this example embodiment is illustrative, and therefore should not be construed as being limiting in any way.

From operation 304, the method 300 can proceed to operation 306. At operation 306, the server computer 120 can determine network connections at the future times and locations determined in operation 304. In some embodiments, the server computer 120 can use the data file or data log calculated in operation 304 and identify, for the locations and times represented by the data file and/or data log, one or more network connections at the locations and/or times. This calculation, however, may not be trivial in various embodiments when attempting to project satellite connectivity at a particular location and/or time.

In particular, direct to satellite connectivity can be provided in various embodiments by one or more satellites that can orbit the earth in low-earth orbit that is not geosynchronous in nature. Thus, the relative location of the one or more satellites can change relative to the surface of the earth over time. Thus, the server computer 120 may access network data 126 that can be used and/or can identify locations of coverage areas CAₛ associated with one or more satellites that provide a direct-to-cell satellite network 112 based on the times determined in operation 304. Thus, for example, the server computer 120 may determine, in operation 306, that a coverage area CAₛ associated with a particular satellite of a direct-to-cell satellite network 112 is projected or predicted to be at a first location L₁ at a first time T₁ and at a second location L₂ at a second time T₂. It should be understood that this example embodiment is illustrative, and therefore should not be construed as being limiting in any way.

In operation 306, the server computer 120 also can determine one or more other network connections that may be expected to be available at the locations and times identified in operation 304. For example, given locations as determined in operation 304, the server computer 120 can be configured to access the network data 126 to identify one or more terrestrial networks at the identified locations (e.g., a cellular network connection that is expected to be available at the location and associated time, a WiFi connection that is expected to be available at the location and the associated time, etc.). Thus, operation 306 can correspond to the server computer 120 identifying one or more network connections expected to be available at a location and time, with at least one of the network connections corresponding to a direct-to-cell satellite network connection. It should be understood that this example embodiment is illustrative, and therefore should not be construed as being limiting in any way.

From operation 306, the method 300 can proceed to operation 308. At operation 308, the server computer 120 can determine mobile applications 110 and/or features thereof that are installed at the user device 102. As explained herein, the user device 102 can be configured to determine the mobile applications 110 and/or features thereof without involvement of the server computer 120 in some embodiments. As such, it should be understood that the embodiment illustrated in FIG. 3 is illustrative and should not be construed as being limiting in any way. In some embodiments, however, such as the embodiment illustrated in FIG. 3, the server computer 120 can be configured to determine, for example based on application data included in the device data 130, one or more mobile applications 110 installed at the user device 102. It should be understood that this example embodiment is illustrative, and therefore should not be construed as being limiting in any way.

Although not separately illustrated in FIG. 3, it can be appreciated that in some embodiments, the server computer 120 can use the knowledge of the mobile applications 110 illustrated at the user device 102 to determine one or more application limitations that are to be implemented at the user device 102. As explained herein, the user device 102 can also be configured to determine any application or feature limitations without involvement of the server computer 120, so this embodiment is illustrative and should not be construed as being limiting in any way. Additional aspects of some example embodiments of determining the application and/or feature limitations of mobile applications 110 by the server computer 120 will be discussed in more detail hereinbelow.

From operation 308, the method 300 can proceed to operation 310. At operation 310, the server computer 120 can generate coverage data 136 for a device such as the user device 102. As is explained herein in more detail, expected locations of the user device 102 at one or more times can be determined, expected network connections at those locations and times can be determined, and coverage data 136 can be generated on these and other determinations. In some embodiments of the concepts and technologies disclosed herein, the coverage data 136 also can include application and/or feature limitations for mobile applications 110 at the user device 102. It should be understood that this example embodiment is illustrative, and therefore should not be construed as being limiting in any way. Additional details of generating the coverage data 136 will be illustrated and described in more detail with reference to FIG. 4.

From operation 310, the method 300 can proceed to operation 312. At operation 312, the server computer 120 can provide the coverage data 136 generated in operation 310 to a device such as the user device 102. According to various embodiments, the server computer 120 can provide the coverage data 136 directly to the user device 102. In some other embodiments, the coverage data 136 can be provided to the user device 102 directly, via an application programming interface (“API”), portal, or the like, which can be exposed and/or accessed by the server computer 120, and/or can be relayed to the user device 102 by and/or via other devices or entities. Regardless of how the coverage data 136 is provided to the user device 102, the server computer 120 can be configured to trigger the delivery of the coverage data 136 to the user device 102 in operation 310. It should be understood that this example embodiment is illustrative, and therefore should not be construed as being limiting in any way.

From operation 312, the method 300 can proceed to operation 314. The method 300 can end at operation 314.

Turning now to FIG. 4, aspects of a method 400 for generating coverage data 136 for limiting applications during direct-to-cell satellite coverage will be described in detail, according to an illustrative embodiment. For purposes of illustrating and describing the concepts of the present disclosure, the method 400 is described herein as being performed by the server computer 120 via execution of one or more software modules such as, for example, the coverage management service 118. It should be understood that additional and/or alternative devices and/or network nodes can provide the functionality described herein via execution of one or more modules, applications, and/or other software including, but not limited to, the coverage management service 118. Thus, the illustrated embodiments are illustrative, and should not be viewed as being limiting in any way.

The method 400 begins at operation 402. At operation 402, the server computer 120 can select a time for which network connections of the user device 102 are to be determined. According to various embodiments of the concepts and technologies disclosed herein, the server computer 120 can be configured to identify one or more times for which network connections are to be identified (e.g., as part of operation 304 in FIG. 3). These one or more times can be determined by projecting locations of the user device 102 (e.g., at one or more times). Thus, in operation 402, the server computer 120 can select a time from a list or log that can include one or more times, where the times can correspond to future times (e.g., at which the location of the user device 102 has been projected and for which network connections are to be predicted). It should be understood that this example embodiment is illustrative, and therefore should not be construed as being limiting in any way.

From operation 402, the method 400 can proceed to operation 404. At operation 404, the server computer 120 can determine an expected location of a device (e.g., the user device 102) at the time identified in operation 402. As explained herein, the server computer 120 can determine an expected location of the user device 102 by identifying a geographic location of the user device 102 at some time (e.g., a current time) and motion of the user device 102 at that time and predicting, projecting, and/or extrapolating the location of the user device 102 to a second time based on the motion or movement of the user device 102. It can be appreciated that the extrapolation or projection of location in this manner can be based on an expectation of constant movement (e.g., a vector of movement having a substantially consistent heading and magnitude (e.g., speed)) in some embodiments. In some other embodiments, the device data 130 obtained by the server computer 120 can include contextual data that can be used to determine an expected location at some time.

For example, the contextual data can be obtained from one or more applications at or used by the user device 102 such as routing applications, calendar applications, or the like, which can be used to determine an expected location of the user device 102 at some time in the future (e.g., at, before, or after an expected arrival time indicated by a routing application; at, before, or after a calendar event; or the like). Thus, the expected location at a particular time can be determined by the server computer 120 by analyzing the location and motion of the user device 102, by analyzing the device data 130, and/or otherwise. Because the expected location of the user device 102 at some time in the future can be determined in additional and/or alternative manners, it should be understood that these example embodiments are illustrative, and therefore should not be construed as being limiting in any way.

From operation 404, the method 400 can proceed to operation 406. At operation 406, the server computer 120 can identify one or more available network connections at the location and time identified in operations 402 and 404. According to various embodiments, the server computer 120 can obtain network data 126. As explained herein, the network data 126 can correspond to a data file, log, or other data structure with one or more records. The network data 126 can indicate and/or describe one or more network resources at one or more locations at one or more times. Thus, for example, the network data 126 can be analyzed to identify one or more network resources that is or are expected to be available at one or more locations at one or more times.

According to various embodiments, the server computer 120 can query or search the network data 126 based on a time and/or location. For example, the server computer 120 can search or query the network data 126 based on time, thereby identifying one or more network resources that is or are available at a time. The server computer 120 can filter the results based on location, in some embodiments, to identify network resources available at the location at the time. In some other embodiments, the server computer 120 can search or query the network data 126 based on location, identifying one or more network resources available at the location, and then can filter the results based on time to identify the network resources available at the location at the time. In yet other embodiments, the server computer 120 can search or query the network data 126 based on time and location to identify the network resources available at the location at the time. Thus, it can be appreciated that the server computer 120 can perform various types of analysis on the network data 126 to identify the one or more network resources that is or are available at a particular location at a particular time. As such, it should be understood that these example embodiments are illustrative, and therefore should not be construed as being limiting in any way.

From operation 406, the method 400 can proceed to operation 408. At operation 408, the server computer 120 can determine if a connection (identified and/or determined in operation 406) is limited. As used herein, a connection may be deemed to be “limited” if that connection is not permanently available at a location. Thus, for example, a satellite connection at a particular location may be limited in time. For example, a coverage area CAₛ associated with a satellite may move over time relative to the surface of the earth and therefore a connection to a satellite may be available at a particular location for a particular time (e.g., the time during which the coverage area CAₛ includes the location). Thus, operation 408 can correspond to determining if a connection identified in operation 406 is available at a particular location for only a limited time, or the like. Similarly, a network connection at a particular location may be available only at particular times (e.g., to provide flex coverage for a network) even though the associated network resource is not moving. Thus, it should be understood that connections may be limited in terms of time, location, or the like for other reasons. As such, it should be understood that the above examples are illustrative and therefore should not be construed as being limiting in any way.

If the server computer 120 determines, in operation 408, that one or more of the network connections identified in operation 406 is limited, the method 400 can proceed to operation 410. At operation 410, the server computer 120 can identify one or more limits for the limited network connections. The limits identified for the connection in operation 410 can correspond to time limits (e.g., times or durations at or during which the connection is available, times or durations for which network connections are expected to weaken or be lost, times or durations for which network connections are expected to be available, or the like), geographical limits (e.g., locations at which a connection may be available at a particular time), capabilities (e.g., what network capabilities may be available for the connection at a time and/or location (e.g., bandwidth limitations, device limitations or the like)), and/or permissions (e.g., what users and/or devices can use the connections, combinations thereof, or the like). These limitations can be determined and added to the coverage data 136 for use in generating informative user interfaces as illustrated and described herein and/or for other reasons. It should be understood that this example embodiment is illustrative, and therefore should not be construed as being limiting in any way.

In various embodiments of the concepts and technologies disclosed herein, the time limits referred to herein can include, but are not limited to, a time at which the network connection (e.g., a direct-to-cell satellite connection provided by the direct-to-cell satellite network 112) will become available (i.e., the connection may not yet be available at the current location of the user device 102); a duration of time during which the location of the user device 102 and the coverage area CAₛ associated with the direct-to-cell satellite network 112 will coincide with each other to the extent that the user device 102 can establish and maintain a direct-to-cell satellite connection with a satellite of the direct-to-cell satellite network 112; a time at which the network connection will become unavailable (e.g., due to permissions, location of the user device 102, location of the coverage area CAₛ associated with one or more satellites of the direct-to-cell satellite network 112; combinations thereof; or the like. Thus, it can be appreciated that operation 410 can include the server computer 120 performing numerous calculations to determine the location of the user device 102 now and as projected in the future; locations of network resources and/or assets and their respective areas of coverage (e.g., one or more coverage area CAₛ associated with one or more satellites of the direct-to-cell satellite network 112); overlapping times and locations for the user device 102 and various network connections; combinations thereof; or the like. It should be understood that this example embodiment is illustrative, and therefore should not be construed as being limiting in any way.

From operation 410, the method 400 can proceed to operation 412. The method 400 also can proceed to operation 412 from operation 408 if the server computer 120 determines, in operation 408, that none of the network connections identified in operation 406 is limited. At operation 412, the server computer 120 can determine if any of the mobile applications 110 installed at the user device 102 and/or features thereof are to be restricted based on the network connections determined in operation 406 and/or based on the connection limits determined in operation 410. According to various embodiments of the concepts and technologies disclosed herein, the server computer 120 can perform operation 412 by querying or searching one or more application catalogs 122 and/or other entities such as application feature services 124 or the like. It should be understood that this example embodiment is illustrative, and therefore should not be construed as being limiting in any way.

If the server computer 120 determines, in operation 412, that one or more of the mobile applications 110 installed at the user device 102 and/or features thereof are to be restricted based on the network connections determined in operation 406 and/or based on the connection limits determined in operation 410, the method 400 can proceed to operation 414. At operation 414, the server computer 120 can identify one or more application limits or restrictions, for example, mobile applications 110 installed at the user device 102 that are to be enabled, disabled, limited, restricted, combinations thereof, or the like, based on the determined network connections and/or the associated connection limitations of those network connections. In various embodiments, the server computer 120 can be configured to obtain information from the application catalog 122 and/or the application feature service 124 and determine, based on the network connections and/or associated limitations determined in operations 406-414, what limitations will be made to the mobile applications 110 at the user device 102 and/or timelines associated with these changes. Thus, in operation 414, the server computer 120 can determine what application limitations and/or restrictions are to be implemented at the user device 102 and timelines for those application limitations or restrictions, in some embodiments. Because the determination of application limitations and/or restrictions can be performed in some embodiments by only the user device 102 without involvement of the server computer 120, it should be understood that the functionality of the server computer 120 as illustrated and described herein with reference to operations 412 and 414 may be omitted in some embodiments. It should be understood that this example embodiment is illustrative, and therefore should not be construed as being limiting in any way.

From operation 414, the method 400 can proceed to operation 416. The method 400 also can proceed to operation 416 from operation 412 if the server computer 120 determines, in operation 412, that there are no application features that will be limited. At operation 416, the server computer 120 can add data that reflects the analysis of operations 406-410 and/or 406-414 to the coverage data 136 (or generate coverage data 136 based on this information). Thus, the server computer 120 can add, to the coverage data 136, data that identifies one or more connections available at a particular location at a particular time; that identifies any limits on the connections; and/or data that identifies any limits or restrictions to apply to the mobile applications 110 and/or features thereof, and can add this and/or other information illustrated and described herein to the coverage data 136 being generated by the server computer 120. It should be understood that this example embodiment is illustrative, and therefore should not be construed as being limiting in any way.

In some embodiments, the server computer 120 also can add, to the coverage data 136, data that identifies one or more mobile applications 110 that are to be restricted, limited, enabled, disabled, or the like, as well as timeframes for the above and/or other network connection changes associated with the user device 102. All of this information can be used to identify one or more network connections at locations over time; what connections will be assigned as primary, secondary, backup, or the like; what application limitations and/or restrictions will apply over time; combinations thereof; or the like. It should be understood that the timeframes can include a start time for application restrictions and/or limitations, a duration for application restrictions and/or limitations, an end time for application restrictions and/or limitations, combinations thereof, or the like. Thus, the user device 102 and/or other entities can use the coverage data 136 and/or other information to provide information relating to when application limitations and/or restrictions may begin, how long they will last, when they will end, combinations thereof, or the like. It should be understood that this example embodiment is illustrative, and therefore should not be construed as being limiting in any way.

From operation 416, the method 400 can proceed to operation 418. At operation 418, the server computer 120 can determine if additional times are to be analyzed to create the coverage data 136. In particular, the server computer 120 can determine how many times are to be analyzed when creating the coverage data 136, and to determine, at operation 418, if all of the times have been analyzed to identify network connections. If the server computer 120 determines, in operation 418, that additional times remain to be analyzed, flow of the method 400 can return to operation 402. As such, it can be appreciated that operations 402-418 can be iterated by the server computer 120 until the server computer 120 determines, in any iteration of operation 418, that all times have been analyzed.

If the server computer 120 determines, in any iteration of operation 418, that no additional times are to be analyzed to create the coverage data 136, the method 400 can proceed to operation 420. The method can end at operation 420.

FIGS. 5A-5G are user interface (“UI”) diagrams showing aspects of UIs for using and/or interacting with the coverage management service 118 and/or the coverage management application 108, according to some illustrative embodiments. FIG. 5A shows an illustrative screen display 500A. According to some embodiments of the concepts and technologies described herein, the screen display 500A can be generated by a device such as the user device 102 via interactions with the coverage management service 118 and/or the coverage management application 108. In particular, according to various embodiments, the user device 102 can generate the screen display 500A and/or other screen displays in conjunction with and/or based upon interactions with the coverage management application 108 described herein, which can be configured to render the screen display 500A using data generated at the user device 102 and/or using locally-generated data such as the device data 130 and/or data provided by the coverage management service 118 such as, for example, the coverage data 136. It should be appreciated that the UI diagram illustrated in FIG. 5A is illustrative of one contemplated example of the UIs that can be generated and/or displayed in accordance with the concepts and technologies disclosed herein, and therefore should not be construed as being limiting in any way.

According to various embodiments, the screen display 500A can be presented, for example, when the user device 102 has determined that the user device 102 will connect at some time in the future to a network that has one or more limitations. In the illustrated example embodiment, the user device 102 has determined that the user device 102 will connect to a satellite connection associated with a direct-to-cell satellite network 112 at a particular time. Of course, the user device 102 may also connect to other networks such as the wireless network 114 and the local network 116. In the example shown in FIG. 5A, the user device 102 is illustrated as displaying a home screen 502. It should be understood that this example embodiment is illustrative, and therefore should not be construed as being limiting in any way. Because one or more elements of the screen display 500A illustrated in FIG. 5A can be displayed at additional and/or alternative times (e.g., when the user device 102 is locked), and because one or more elements of the screen display 500A may or may not be included in all embodiments, it should be understood that the illustrated example embodiment is illustrative and therefore should not be construed as being limiting in any way.

As is generally understood, the home screen 502 can be configured to present some information and/or options to a user while the user device 102 is unlocked. For example, as is known and as is illustrated in FIG. 5A, the home screen 502 can include various types of data and/or information such as time and/or date information 504, which can display a time and/or date; carrier information (not illustrated in FIG. 5A), which can be included to indicate a carrier associated with a primary network connection and/or network to which the user device 102 is connected at the time; signal strength information 506 for the primary network connection, which can indicate a strength of a signal associated with the primary network to which the user device 102 is connected at the time; a WiFi signal indicator 508, which can indicate in some instances that a WiFi connection is available, active, and optionally an associated signal strength of the WiFi signal; battery charge information 510; and one or more application icons 512 (only some of the application icons 512 are labeled in FIG. 5A to avoid obscuring additional details of the home screen 502).

As shown in FIG. 5A, a status of one or more networks can be displayed on the home screen 502 and/or elsewhere. In the illustrated embodiment, a status of “active” is displayed under the signal strength information 506, thereby indicating that the primary network connection is active at the current time; and a status of “backup” is displayed under the WiFi signal indicator 508, thereby indicating that a WiFi connection is active at the current time and functioning as a backup connection for the user device 102. It should be understood that this example embodiment is illustrative, and therefore should not be construed as being limiting in any way.

As is generally understood, the application icons 512 can be interacted with (e.g., by tapping or the like) to launch and/or access functionality associated with one or more of the mobile applications 110 that are installed at the user device 102. Additionally, as is generally understood, the home screen 502 can be configured to display folders 514 of multiple application icons 512 and/or a quick access dock 516 for displaying application icons 512 for certain mobile applications 110, in some embodiments. Because additional and/or alternative information may be included on the home screen 502, it should be understood that the illustrated example is illustrative and therefore should not be construed as being limiting in any way.

In accordance with various embodiments of the concepts and technologies disclosed herein, the screen display 502 also can include a direct-to-cell satellite network status indicator 518. The direct-to-cell satellite network status indicator 518 is illustrated in FIG. 5A as being displayed. As shown in FIG. 5A, the direct-to-cell satellite network status indicator 518 can indicate that a satellite connection is expected to be available and active for the user device 102 in another four minutes and thirty-seven seconds. In some embodiments, the text associated with the direct-to-cell satellite network status indicator 518 can scroll or otherwise change to provide additional information. It should be understood that this example embodiment is illustrative, and therefore should not be construed as being limiting in any way.

According to various embodiments of the concepts and technologies disclosed herein, the direct-to-cell satellite network status indicator 518 can be generated by the user device 102 (e.g., via execution of the coverage management application 108) based on the device data 130 and/or the coverage data 136, which collectively and/or independently can indicate that a connection to the direct-to-cell satellite network 112 is available at the user device 102 and that the user device 102 is expected to connect to the direct-to-cell satellite network 112 in a particular amount of time. Because the illustrated embodiment is an example, and because the screen display 500A can include additional and/or alternative information, it should be understood that the embodiment of FIG. 5A is illustrative, and therefore should not be construed as being limiting in any way.

FIG. 5B shows an illustrative screen display 500B. As shown in FIG. 5B, the direct-to-cell satellite network status indicator 518 can be configured as a UI control that, when selected (e.g., by being tapped by a user as illustrated in FIG. 5B), causes the user device 102 to update the screen display 500B to present application restrictions and/or limitations on the home screen 502. An example embodiment of some embodiments of updated screen displays are illustrated and described hereinbelow. It should be understood that this example embodiment is illustrative, and therefore should not be construed as being limiting in any way.

FIG. 5C shows an illustrative screen display 500C. According to some embodiments of the concepts and technologies described herein, the screen display 500C can be generated by a device such as the user device 102 via interactions with the coverage management service 118 and/or the coverage management application 108. In particular, according to various embodiments, the user device 102 can generate the screen display 500C and/or other screen displays in conjunction with and/or based upon interactions with the coverage management application 108 described herein, which can be configured to render the screen display 500C using data generated at the user device 102 and/or using locally-generated data such as the device data 130 and/or data provided by the coverage management service 118 such as, for example, the coverage data 136. It should be appreciated that the UI diagram illustrated in FIG. 5C is illustrative of one contemplated example of the UIs that can be generated and/or displayed in accordance with the concepts and technologies disclosed herein, and therefore should not be construed as being limiting in any way.

According to various embodiments, the screen display 500C can be presented, for example, when the user device 102 detects a selection of the direct-to-cell satellite network status indicator 518, for example by a user or other entity tapping or otherwise selecting the direct-to-cell satellite network status indicator 518, as illustrated in FIG. 5B. Because one or more elements of the screen display 500C illustrated in FIG. 5C can be displayed at additional and/or alternative times (e.g., without a user or other entity selecting the direct-to-cell satellite network status indicator 518), it should be understood that this example is illustrative and therefore should not be construed as being limiting in any way.

In FIG. 5C, the home screen 502 can include application limitation and/or restriction badges 520A-D (hereinafter collectively and/or generically referred to as “application limitation badges 520”). The application limitation badges 520 can indicate one or more application restrictions or limitations that apply to a mobile application 110 associated with the respective application icon 512 on which the application limitation badge 520 is superimposed. Because the superimposition of an application limitation badge 520 is only one example embodiment of communicating application restrictions and/or limitations at the user device 102, it should be understood that the illustrated embodiment is illustrative and should not be construed as being limiting in any way.

In the embodiment shown in FIG. 5C, the application icon 512 associated with the calendar application installed at the user device 102 does not include an application limitation badge 520, thereby indicating that functionality of the calendar application may continue to function without any changes, limitations, restrictions, or the like when the user device 102 connects to a satellite connection provided by the direct-to-cell satellite network 112 (in about four minutes and twenty-one seconds in the illustrated embodiment of FIG. 5C). It should be understood that this example embodiment is illustrative, and therefore should not be construed as being limiting in any way.

As shown in FIG. 5C, some of the application icons 512 can include superimposed application limitation badges 520 such as the application limitation badge 520A, which can indicate that the associated mobile application 110 (in the illustrated embodiment, the music application) may be limited to local execution and/or use of local data when the network connection changes. Thus, it can be appreciated that application limitation badges 520 can show that one or more mobile applications 110 will be limited to local execution and/or local data when a network connection changes. In the embodiment illustrated in FIG. 5C, the superimposed application limitation badges 520 that read “local” are displayed with a number of application icons 512 and folders 514. It can be appreciated that when a folder 514 is displayed with a superimposed application limitation badge 520, that all mobile applications 110 represented by the application icons 512 in the folder 514 may all be limited to local execution and/or local data. In some embodiments, an application limitation badge 520 reading “mixed” or other status can be superimposed on folders 514 as well. It should be understood that this example embodiment is illustrative, and therefore should not be construed as being limiting in any way.

As shown in FIG. 5C, some of the application icons 512 can include superimposed application limitation badges 520 such as the application limitation badge 520B, which can read “text only,” thereby indicating that the associated mobile application 110 (in the illustrated embodiment, the WhatsApp messaging application and the messaging application) may be limited to text only, thereby indicating that other functionality associated with those mobile applications 110 (e.g., sending videos, sending audio, sending images, and the like) may not be available when the network connection of the user device 102 changes. Thus, it can be appreciated that application limitation badges 520 can show that one or more features or functions of one or more mobile applications 110 may be limited when a network connection changes for the user device 102. It should be understood that this example embodiment is illustrative, and therefore should not be construed as being limiting in any way.

As shown in FIG. 5C, some of the application icons 512 can include superimposed application limitation badges 520 such as the application limitation badge 520C, which can read “disabled.” An application limitation badge 520 such as the application limitation badge 520C can indicate that the associated mobile application 110 (in the illustrated embodiment, the music store application, the video application, and several other applications) are illustrated as being disabled entirely, thereby indicating that all functionality associated with those mobile applications 110 may not be available when the network connection of the user device 102 changes. Thus, it can be appreciated that application limitation badges 520 can show that one or more mobile applications 110 may be disabled when a network connection changes for the user device 102. It should be understood that this example embodiment is illustrative, and therefore should not be construed as being limiting in any way.

As shown in FIG. 5C, some of the application icons 512 can include superimposed application limitation badges 520 such as the application limitation badge 520D, which can read “voice only,” thereby indicating that the associated mobile application 110 (in the illustrated embodiment, the telephone application) may be limited to voice only, thereby indicating that other functionality associated with those mobile applications 110 (e.g., voicemail, video calling, and the like) may not be available when the network connection of the user device 102 changes. Thus, it can be appreciated that application limitation badges 520 can show that one or more features or functions of one or more mobile applications 110 may be limited when a network connection changes for the user device 102. It should be understood that this example embodiment is illustrative, and therefore should not be construed as being limiting in any way. It should be understood that the example embodiment shown in FIG. 5C is illustrative, and therefore should not be construed as being limiting in any way.

FIG. 5D shows an illustrative screen display 500D. According to some embodiments of the concepts and technologies described herein, the screen display 500D can be generated by a device such as the user device 102 via interactions with the coverage management service 118 and/or the coverage management application 108. In particular, according to various embodiments, the user device 102 can generate the screen display 500D and/or other screen displays in conjunction with and/or based upon interactions with the coverage management application 108 described herein, which can be configured to render the screen display 500D using data generated at the user device 102 and/or using locally-generated data such as the device data 130 and/or data provided by the coverage management service 118 such as, for example, the coverage data 136. It should be appreciated that the UI diagram illustrated in FIG. 5D is illustrative of one contemplated example of the UIs that can be generated and/or displayed in accordance with the concepts and technologies disclosed herein, and therefore should not be construed as being limiting in any way.

According to various embodiments, the screen display 500D can be presented, for example, when the user device 102 has connected to a direct-to-cell satellite connection associated with a direct-to-cell satellite network 112. In the illustrated embodiment, the primary network previously connected to by the user device 102 in FIGS. 5A-5C, namely a connection associated with the wireless network 114, is illustrated as being offline, and a direct-to-satellite connection associated with a direct-to-cell satellite network 112 is displayed, as indicated by a direct-to-cell satellite indicator 522, which is labeled with a status of “active,” while the signal strength information 506 is displayed with a status of “offline.” Thus, it can be appreciated that the user device 102 may be in a coverage area CAₛ associated with a direct-to-cell satellite network 112 at a current time. Because one or more elements of the screen display 500D illustrated in FIG. 5D can be displayed at additional and/or alternative times (e.g., when the user device 102 is locked), and because one or more elements of the screen display 500D may or may not be displayed in all embodiments, it should be understood that the illustrated example embodiment is illustrative and therefore should not be construed as being limiting in any way.

In FIG. 5D, the home screen 502 can include the direct-to-cell satellite network status indicator 518. As shown in FIG. 5D, the direct-to-cell satellite network status indicator 518 can indicate that the application restrictions and/or limitations indicated by the various application limitation badges 520 now apply, and that these application restrictions and/or limitations will apply for another nine minutes and forty-seven seconds. Thus, it can be appreciated that the user device 102 can be expected to reconnect to another network connection after another nine minutes and forty-seven seconds, at which time the application limitations and/or restrictions may no longer apply. It should be understood that this example embodiment is illustrative, and therefore should not be construed as being limiting in any way. Thus, it can be appreciated that the user device 102 can update user interfaces to reflect when application limitations or restrictions will begin, how long application restrictions or limitations will last once they begin, when application limitations and/or restrictions will end, and the like. Because additional and/or alternative information can be displayed on the screen display 500D, it should be understood that the example embodiment shown in FIG. 5D is illustrative, and therefore should not be construed as being limiting in any way.

FIG. 5E shows an illustrative screen display 500E. According to some embodiments of the concepts and technologies described herein, the screen display 500E can be generated by a device such as the user device 102 via interactions with the coverage management service 118 and/or the coverage management application 108. In particular, according to various embodiments, the user device 102 can generate the screen display 500E and/or other screen displays in conjunction with and/or based upon interactions with the coverage management application 108 described herein, which can be configured to render the screen display 500E using data generated at the user device 102 and/or using locally-generated data such as the device data 130 and/or data provided by the coverage management service 118 such as, for example, the coverage data 136. It should be appreciated that the UI diagram illustrated in FIG. 5E is illustrative of one contemplated example of the UIs that can be generated and/or displayed in accordance with the concepts and technologies disclosed herein, and therefore should not be construed as being limiting in any way.

In FIG. 5E, the screen display 500E can display an alternative view of the home screen 502 shown in FIGS. 5A-5D. In particular, as seen in FIG. 5E, the direct-to-cell satellite network status indicator 518 is hidden in FIG. 5E, and the application status badges 514 can include a status and a time for which the current status will apply. Namely, each application status badge 514 can indicate whether functionality is limited, unavailable, or the like; as well as a time for which this status will apply for the associated application. As such, it can be appreciated that various embodiments of the user interfaces illustrated and described herein are possible and are contemplated. Because additional and/or alternative embodiments for the home screen 502 and the display of information relating to network connections and/or application limitations are possible, it should be understood that this example embodiment is illustrative, and therefore should not be construed as being limiting in any way.

FIG. 5F shows an illustrative screen display 500F. According to some embodiments of the concepts and technologies described herein, the screen display 500F can be generated by a device such as the user device 102 via interactions with the coverage management service 118 and/or the coverage management application 108. In particular, according to various embodiments, the user device 102 can generate the screen display 500F and/or other screen displays in conjunction with and/or based upon interactions with the coverage management application 108 described herein, which can be configured to render the screen display 500F using data generated at the user device 102 and/or using locally-generated data such as the device data 130 and/or data provided by the coverage management service 118 such as, for example, the coverage data 136. It should be appreciated that the UI diagram illustrated in FIG. 5F is illustrative of one contemplated example of the UIs that can be generated and/or displayed in accordance with the concepts and technologies disclosed herein, and therefore should not be construed as being limiting in any way.

According to various embodiments, the screen display 500F can be presented, for example, when a mobile application 110 having limited functionality such as application restrictions or limitations, for example, as a result of the user device 102 being connected to a network connection having limited capabilities. For example, the screen display 500F may be displayed when the user device 102 is connected to a satellite connection provided by the direct-to-cell satellite network 112, for example, and the satellite connection may have a lower bandwidth than some other network connections. Because one or more elements of the screen display 500F illustrated in FIG. 5F can be displayed at additional and/or alternative times, it should be understood that the above example conditions are illustrative and therefore should not be construed as being limiting in any way.

In FIG. 5F, the screen display 500F can include a messaging application screen 530, which can be used to send and/or receive messages in some embodiments. The screen display 500F also can include the signal strength information 506, which can indicate that the primary network (e.g., a cellular connection provided by a wireless network 114) is offline and/or that the user device 102 is not connected to that connection; and the direct-to-cell satellite indicator 522, which can indicate that the user device 102 is connected to the direct-to-cell satellite network 112. As shown in the example embodiments illustrated above, a messaging application that generates the messaging application screen 530 may have limited capabilities due to the direct-to-satellite connection and associated limited capabilities of that network in some embodiments. In the illustrated embodiment, the messaging application can be limited to sending and/or receiving text only (e.g., sending and/or receiving images, video, audio, or the like may be restricted or blocked). Thus, when a user or other entity creates a message for sending, the messaging application screen 530 can include various elements for messaging, as well as other elements for informing a user or other entity as to the limitations of the messaging application (other mobile applications 110 can have similar and/or other types of limitations that can be communicated as illustrated and described herein). It should be understood that this example embodiment is illustrative, and therefore should not be construed as being limiting in any way.

In the illustrated embodiment, the messaging application screen 530 is illustrated as including an image 532 and a text message 534. As is generally understood, the user or other entity associated with the user device 102 may create a message that includes the image 532 and the text message 534 for sending to a recipient. According to various embodiments of the concepts and technologies disclosed herein, however, the messaging application being used is limited at a current time based on the network connection associated with the user device 102. Thus, embodiments of the concepts and technologies disclosed herein include providing an application limitation or restriction notice (“application limitation notice”) 536 to a user or other entity within the mobile application 110.

In the illustrated embodiment, the application limitation notice 536 can include an indication 538 that functionality of the mobile application 110 being used is limited and a time for which that limitation applies; an explanation 540 about the limitation and how and when the image 532 and/or text message 534 can be sent; and an indication 542 of an estimated send time. It can be appreciated that the estimated send time can correspond to a time at which the user device 102 is expected to connect to another network connection that will not result in limiting functionality and/or features of the mobile application 110 currently being used (e.g., the messaging application). It also can be appreciated that the user device 102 can generate the application limitation notice 536 and the contents thereof using the coverage data 136 and other information gathered at the user device 102 as illustrated and described herein. It should be understood that the example embodiment of the application limitation notice 536 and other elements of the screen display 500F shown in FIG. 5F is illustrative, and therefore should not be construed as being limiting in any way.

FIG. 5G shows an illustrative screen display 500G. According to some embodiments of the concepts and technologies described herein, the screen display 500G can be generated by a device such as the user device 102 via interactions with the coverage management service 118 and/or the coverage management application 108. In particular, according to various embodiments, the user device 102 can generate the screen display 500G and/or other screen displays in conjunction with and/or based upon interactions with the coverage management application 108 described herein, which can be configured to render the screen display 500G using data generated at the user device 102 and/or using locally-generated data such as the device data 130 and/or data provided by the coverage management service 118 such as, for example, the coverage data 136. It should be appreciated that the UI diagram illustrated in FIG. 5G is illustrative of one contemplated example of the UIs that can be generated and/or displayed in accordance with the concepts and technologies disclosed herein, and therefore should not be construed as being limiting in any way.

According to various embodiments, the screen display 500G can be presented, for example, when a mobile application 110 having limited functionality such as application restrictions or limitations, for example, as a result of the user device 102 being connected to a network connection having limited capabilities. For example, the screen display 500G may be displayed when the user device 102 is connected to a satellite connection provided by the direct-to-cell satellite network 112, for example, and the satellite connection may have a lower bandwidth than some other network connections. Because one or more elements of the screen display 500G illustrated in FIG. 5G can be displayed at additional and/or alternative times, it should be understood that the above example conditions are illustrative and therefore should not be construed as being limiting in any way.

In FIG. 5G, the screen display 500G includes a messaging application screen 530. The screen display 500G also can include the signal strength information 506, which can indicate that the primary network (e.g., a cellular connection provided by a wireless network 114) is offline and/or that the user device 102 is not connected to that connection; and the direct-to-cell satellite indicator 522, which can indicate that the user device 102 is connected to the direct-to-cell satellite network 112. As shown in the example embodiments illustrated above, a messaging application that generates the messaging application screen 530 may currently have limited capabilities due to the direct-to-satellite connection and associated limited capabilities of that network in some embodiments. In the illustrated embodiment, the messaging application can be limited to sending and/or receiving text only (e.g., sending and/or receiving images, video, audio, or the like may be restricted or blocked). Thus, when a user or other entity receives a message that was sent with audio, video, and/or images at the user device 102, the messaging application screen 530 can be configured to provide an indication that this data (e.g., the audio, video, and/or image) has not yet been delivered and information relating to how and/or when the data will be delivered.

It can be appreciated that in various embodiments, a device on a network (e.g., a messaging server or the like) that relays a message that includes the video, image, audio, or the like can be configured to block the image, video, audio, or the like until the user device 102 reconnects to a suitable network connection. Thus, it can be appreciated that the coverage management service 118 can be configured to report the status of the user device 102 to a messaging server and/or other applications, entities, and/or resources on a network 104, 112, 114, 116 to alter functionality of the services for the user device 102. In some other embodiments, the coverage management service 118 may inform a gateway, radio unit (“RU”), or other entity that sends data to the user device 102 regarding restrictions and/or limitations of the user device 102 and/or mobile applications 110 executed thereby, and the RU or other device can block delivery of the video, image, audio, or the like. Because messages and/or components thereof can be blocked in additional and/or alternative manners, it should be understood that these example embodiments are illustrative, and therefore should not be construed as being limiting in any way. At any rate, the messaging application screen 530 can include various elements for reviewing messages, as well as other elements for informing a user or other entity as to the limitations of the messaging application (other mobile applications 110 can have similar and/or other types of limitations that can be communicated as illustrated and described herein). It should be understood that this example embodiment is illustrative, and therefore should not be construed as being limiting in any way.

In the illustrated embodiment, the messaging application screen 530 is illustrated as including a limited functionality notification 550. The limited functionality notification 550 can inform a user or other entity that a mobile application 110 associated with the messaging application screen 530 (e.g., a messaging application) is limited, types of limitations currently in place (e.g., that only text can be sent and/or received; that video, audio, and images cannot be sent; combinations thereof; or the like), a time duration for the limitations (or an end time), combinations thereof, or the like. Because the limited functionality notification 550 can include additional and/or alternative information, it should be understood that this example embodiment is illustrative, and therefore should not be construed as being limiting in any way.

In the illustrated embodiment, the messaging application screen 530 includes a message window 552, which can correspond to and/or represent a message received by the user device 102, as is generally understood. The message window 552 also can include an indication 554 that functionality of the mobile application 110 being used to receive and/or review the message is limited; a summary 556 of the message and the content that has not been delivered (in the example embodiments, a video file); and an estimated delivery time at which the limited or restricted content (e.g., a video) will be delivered to the user device 102. It can be appreciated that the estimated delivery time can correspond to a time at which the user device 102 is expected to connect to another network connection that will not result in limiting functionality and/or features of the mobile application 110 currently being used (e.g., the messaging application), at which time the restricted or limited content can be delivered to the user device 102. It also can be appreciated that the user device 102 can generate the messaging application screen 530 and the contents thereof using the coverage data 136 and other information gathered at the user device 102 as illustrated and described herein. It should be understood that the example embodiment the screen display 500G shown in FIG. 5G is illustrative, and therefore should not be construed as being limiting in any way.

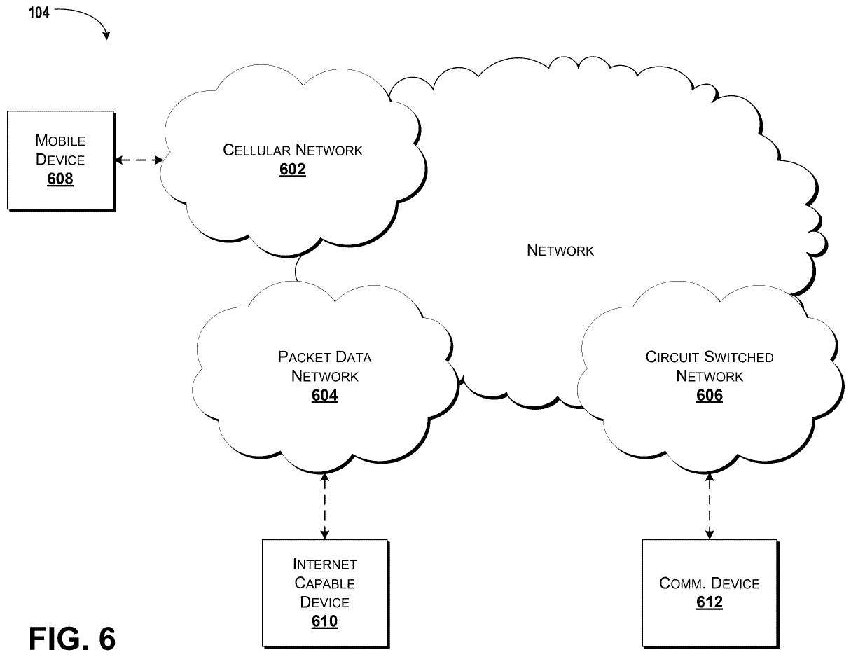

Turning now to FIG. 6, additional details of the network 104 are illustrated, according to an illustrative embodiment. The network 104 includes a cellular network 602, a packet data network 604, for example, the Internet, and a circuit switched network 606, for example, a publicly switched telephone network (“PSTN”). The cellular network 602 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 602 also can include various interfaces between various components, as is generally understood. The cellular network 602 also includes radios and nodes for receiving and transmitting voice, data, and combinations thereof to and from radio transceivers, networks, the packet data network 604, and the circuit switched network 606.

A mobile communications device 608, such as, for example, a cellular telephone, a user equipment, a mobile terminal, a PDA, a laptop computer, a handheld computer, and combinations thereof, can be operatively connected to the cellular network 602. The cellular network 602 can be configured as a 2G GSM network and can provide data communications via GPRS and/or EDGE. Additionally, or alternatively, the cellular network 602 can be configured as a 3G UMTS network and can provide data communications via the HSPA protocol family, for example, HSDPA, EUL (also referred to as HSUPA), and HSPA+. The cellular network 602 also is compatible with 4G mobile communications standards, 5G mobile communications standards, 6G mobile communication standards, other mobile communications standards, and evolved and future mobile communications standards. Moreover, the cellular network 602 may facilitate communications over various channel access methods (which may or may not be used by the aforementioned standards) including, but not limited to, TDMA, FDMA, W-CDMA, OFDM, SDMA, and the like. In addition, the cellular network 602 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 604 includes various devices, for example, servers, computers, databases, and other devices in communication with one another, as is generally known. The packet data network 604 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (POTS). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 610, for example, a PC, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610. In the specification, the network 104 is used to refer broadly to any combination of the networks 602, 604, 606. It should be appreciated that substantially all of the functionality described with reference to the network 104 can be performed by the cellular network 602, the packet data network 604, and/or the circuit switched network 606, alone or in combination with other networks, network elements, and the like.

As explained herein, the network 104 also can include and/or can access a direct-to-cell satellite network (not visible in FIG. 6). As is generally understood, a direct-to-cell satellite network can include one or more satellites (or constellations of satellites), which can be configured to communicate directly with a mobile device such as the user device 102 illustrated and described herein, which as explained herein can include and/or can be similar to the mobile communications device 608 shown in FIG. 6, a vehicle computing system (e.g., a communications device of a connected car system), and/or other devices that can use the direct-to-cell satellite network to bypass terrestrial wireless networks such as the cellular network 602 and/or some components thereof. The satellites of a direct-to-cell satellite network may be located in low earth orbit and therefore the coverage areas CAₛ of satellites of direct-to-cell satellite networks may move relative to the surface of the earth over time. Embodiments of the concepts and technologies disclosed herein can include connectivity to these and other networks as illustrated and described herein.

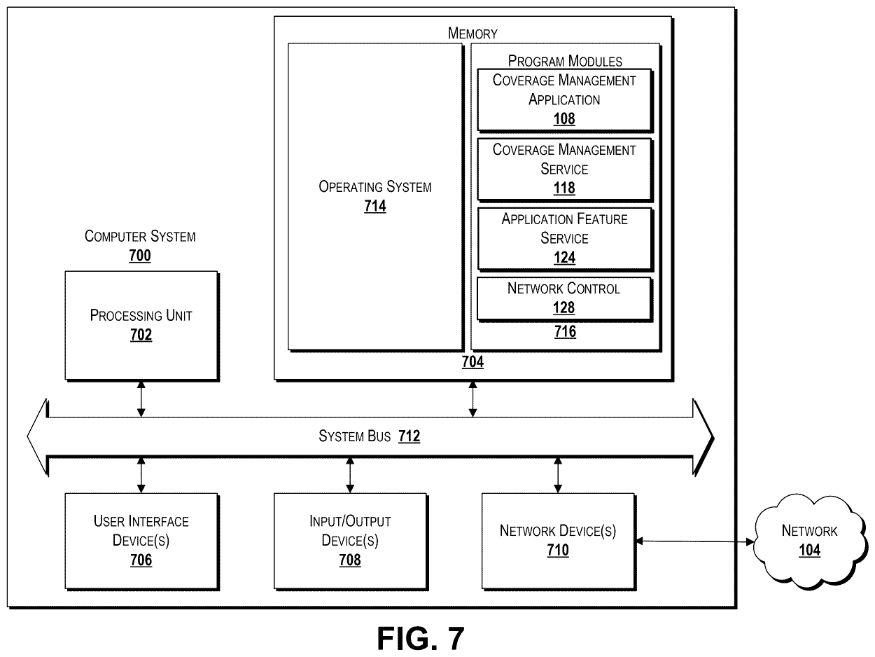

FIG. 7 is a block diagram illustrating a computer system 700 configured to provide the functionality described herein for providing determining and using application limitations during direct-to-cell satellite coverage, in accordance with various embodiments of the concepts and technologies disclosed herein. The computer system 700 includes a processing unit 702, a memory 704, one or more user interface devices 706, one or more input/output (“I/O”) devices 708, and one or more network devices 710, each of which is operatively connected to a system bus 712. The system bus 712 can enable bi-directional communication between the processing unit 702, the memory 704, the user interface devices 706, the I/O devices 708, and the network devices 710.

The processing unit 702 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 704 communicates with the processing unit 702 via the system bus 712. In some embodiments, the memory 704 is operatively connected to a memory controller (not shown) that enables communication with the processing unit 702 via the system bus 712. The memory 704 includes an operating system 714 and one or more program modules 716. The operating system 714 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 716 may include various software and/or program modules described herein. In some embodiments, for example, the program modules 716 can include the coverage management application 108, the mobile applications 110, the coverage management service 118, the application feature service 124, and/or the network control 128 (though not all are illustrated in FIG. 7). These and/or other programs can be embodied in computer-readable media containing instructions that, when executed by the processing unit 702, perform one or more of the methods 200, 300, and 400 described in detail above with respect to FIGS. 2-4 and/or other functionality as illustrated and described herein. It can be appreciated that, at least by virtue of the instructions embodying the methods 200, 300, 400, and/or other functionality illustrated and described herein being stored in the memory 704 and/or accessed and/or executed by the processing unit 702, the computer system 700 is a special-purpose computing system that can facilitate providing the functionality illustrated and described herein. According to embodiments, the program modules 716 may be embodied in hardware, software, firmware, or any combination thereof. Although not shown in FIG. 7, it should be understood that the memory 704 also can be configured to store the mobile applications 110, the application catalog 122, the network data 126, the device data 130, the user database 132, the coverage data 136, and/or other data, if desired.

By way of example, and not limitation, computer-readable media may include any available computer storage media or communication media that can be accessed by the computer system 700. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 700. In the claims, the phrase “computer storage medium” and variations thereof does not include waves or signals per se and/or communication media.

The user interface devices 706 may include one or more devices with which a user accesses the computer system 700. The user interface devices 706 may include, but are not limited to, computers, servers, personal digital assistants, cellular phones, or any suitable computing devices. The I/O devices 708 enable a user to interface with the program modules 716. In one embodiment, the I/O devices 708 are operatively connected to an I/O controller (not shown) that enables communication with the processing unit 702 via the system bus 712. The I/O devices 708 may include one or more input devices, such as, but not limited to, a keyboard, a mouse, or an electronic stylus. Further, the I/O devices 708 may include one or more output devices, such as, but not limited to, a display screen or a printer.

The network devices 710 enable the computer system 700 to communicate with other networks or remote systems via a network, such as the network 104. Examples of the network devices 710 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

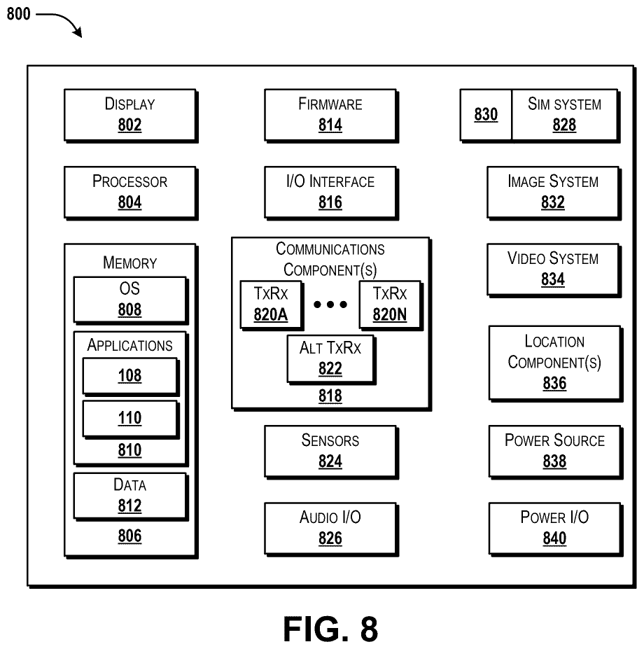

Turning now to FIG. 8, an illustrative mobile device 800 and components thereof will be described. In some embodiments, the user device 102 described above with reference to FIGS. 1-5G can be configured as and/or can have an architecture similar or identical to the mobile device 800 described herein in FIG. 8. It should be understood, however, that the user device 102 may or may not include the functionality described herein with reference to FIG. 8. While connections are not shown between the various components illustrated in FIG. 8, it should be understood that some, none, or all of the components illustrated in FIG. 8 can be configured to interact with one another to carry out various device functions. In some embodiments, the components are arranged so as to communicate via one or more busses (not shown). Thus, it should be understood that FIG. 8 and the following description are intended to provide a general understanding of a suitable environment in which various aspects of embodiments can be implemented, and should not be construed as being limiting in any way.

As illustrated in FIG. 8, the mobile device 800 can include a display 802 for displaying data. According to various embodiments, the display 802 can be configured to display various graphical user interface (“GUI”) elements such as, for example, elements for indicating one or more active or available network connections, time until a network connection will be available, costs for using a network connection, limitations of a network connection, a status of network connection (e.g., active, inactive, available, unavailable, primary, secondary, etc.), text, images, video, virtual keypads and/or keyboards, messaging data, notification messages, metadata, internet content, device status, time, date, calendar data, device preferences, map and location data, combinations thereof, and/or the like. The mobile device 800 also can include a processor 804 and a memory or other data storage device (“memory”) 806. The processor 804 can be configured to process data and/or can execute computer-executable instructions stored in the memory 806. The computer-executable instructions executed by the processor 804 can include, for example, an operating system 808, one or more applications 810 such as, for example, the coverage management application 108, the mobile applications 110, the application feature service 124, the network control 128, the coverage management service 118, other computer-executable instructions stored in a memory 806, or the like (though only the coverage management application 108 and the mobile applications 110 are illustrated in FIG. 8). In some embodiments, the applications 810 also can include a UI application (not illustrated in FIG. 8).

The UI application can interface with the operating system 808, such as the operating system 106 shown in FIG. 1, to facilitate user interaction with functionality and/or data stored at the mobile device 800 and/or stored elsewhere. In some embodiments, the operating system 808 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 804 to aid a user in entering content, providing network connection status and details, configuring settings, manipulating address book content and/or settings, multimode interaction, interacting with other applications 810, and otherwise facilitating user interaction with the operating system 808, the applications 810, and/or other types or instances of data 812 that can be stored at the mobile device 800. The data 812 can include, for example, the coverage management application 108, the coverage management service 118, the application feature service 124, the network control 128, and/or other applications or program modules. According to various embodiments, the data 812 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 810, the data 812, and/or portions thereof can be stored in the memory 806 and/or in a firmware 814, and can be executed by the processor 804.

It can be appreciated that, at least by virtue of storage of the instructions corresponding to the applications 810 and/or other instructions embodying other functionality illustrated and described herein in the memory 806, and/or by virtue of the instructions corresponding to the applications 810 and/or other instructions embodying other functionality illustrated and described herein being accessed and/or executed by the processor 804, the mobile device 800 is a special-purpose mobile device that can facilitate providing the functionality illustrated and described herein. The firmware 814 also can store code for execution during device power up and power down operations. It can be appreciated that the firmware 814 can be stored in a volatile or non-volatile data storage device including, but not limited to, the memory 806 and/or a portion thereof.

The mobile device 800 also can include an input/output (“I/O”) interface 816. The I/O interface 816 can be configured to support the input/output of data such as location information, the application catalog 122, the network data 126, the device data 130, the user database 132, the coverage data 136, user information, organization information, presence status information, user IDs, passwords, and application initiation (start-up) requests. In some embodiments, the I/O interface 816 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 800 can be configured to synchronize with another device to transfer content to and/or from the mobile device 800. In some embodiments, the mobile device 800 can be configured to receive updates to one or more of the applications 810 via the I/O interface 816, though this is not necessarily the case. In some embodiments, the I/O interface 816 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 816 may be used for communications between the mobile device 800 and a network device or local device.

The mobile device 800 also can include a communications component 818. The communications component 818 can be configured to interface with the processor 804 to facilitate wired and/or wireless communications with one or more networks such as the network 104, the direct-to-cell satellite network 112, the wireless network 114, and/or the local network 116 described herein. In some embodiments, other networks include networks that utilize non-cellular wireless technologies such as WI-FI or WIMAX. In some embodiments, the communications component 818 includes a multimode communications subsystem for facilitating communications via the cellular network and one or more other networks.

The communications component 818, in some embodiments, includes one or more transceivers. The one or more transceivers, if included, can be configured to communicate over the same and/or different wireless technology standards with respect to one another. For example, in some embodiments one or more of the transceivers of the communications component 818 may be configured to communicate using GSM, CDMAONE, CDMA2000, LTE, and various other 2G, 2.5G, 3G, 4G, 5G, 6G, and greater generation technology standards. Moreover, the communications component 818 may facilitate communications over various channel access methods (which may or may not be used by the aforementioned standards) including, but not limited to, TDMA, FDMA, W-CDMA, OFDM, SDMA, and the like.

In addition, the communications component 818 may facilitate data communications using GPRS, EDGE, the HSPA protocol family including HSDPA, EUL or otherwise termed HSUPA, HSPA+, and various other current and future wireless data access standards. In the illustrated embodiment, the communications component 818 can include a first transceiver (“TxRx”) 820A that can operate in a first communications mode (e.g., GSM). The communications component 818 also can include an Nt^{h} transceiver (“TxRx”) 820N that can operate in a second communications mode relative to the first transceiver 820A (e.g., UMTS). While two transceivers 820A-N (hereinafter collectively and/or generically referred to as “transceivers 820”) are shown in FIG. 8, it should be appreciated that less than two, two, and/or more than two transceivers 820 can be included in the communications component 818.

The communications component 818 also can include an alternative transceiver (“Alt TxRx”) 822 for supporting other types and/or standards of communications. According to various contemplated embodiments, the alternative transceiver 822 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 818 also can facilitate reception from terrestrial radio networks, digital satellite radio networks, internet-based radio service networks, combinations thereof, and the like. The communications component 818 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 800 also can include one or more sensors 824. The sensors 824 can include temperature sensors, light sensors, air quality sensors, movement sensors, orientation sensors, noise sensors, proximity sensors, or the like. As such, it should be understood that the sensors 824 can include, but are not limited to, accelerometers, magnetometers, gyroscopes, infrared sensors, noise sensors, microphones, combinations thereof, or the like. Additionally, audio capabilities for the mobile device 800 may be provided by an audio I/O component 826. The audio I/O component 826 of the mobile device 800 can include one or more speakers for the output of audio signals, one or more microphones for the collection and/or input of audio signals, and/or other audio input and/or output devices.

The illustrated mobile device 800 also can include a subscriber identity module (“SIM”) system 828. The SIM system 828 can include a universal SIM (“USIM”), a universal integrated circuit card (“UICC”) and/or other identity devices. The SIM system 828 can include and/or can be connected to or inserted into an interface such as a slot interface 830. In some embodiments, the slot interface 830 can be configured to accept insertion of other identity cards or modules for accessing various types of networks. Additionally, or alternatively, the slot interface 830 can be configured to accept multiple subscriber identity cards. Because other devices and/or modules for identifying users and/or the mobile device 800 are contemplated, it should be understood that these embodiments are illustrative, and should not be construed as being limiting in any way.

The mobile device 800 also can include an image capture and processing system 832 (“image system”). The image system 832 can be configured to capture or otherwise obtain photos, videos, and/or other visual information. As such, the image system 832 can include cameras, lenses, charge-coupled devices (“CCDs”), combinations thereof, or the like. The mobile device 800 may also include a video system 834. The video system 834 can be configured to capture, process, record, modify, and/or store video content. Photos and videos obtained using the image system 832 and the video system 834, respectively, may be added as message content to an MMS message, email message, and sent to another mobile device. The video and/or photo content also can be shared with other devices via various types of data transfers via wired and/or wireless communication devices as described herein.

The mobile device 800 also can include one or more location components 836. The location components 836 can be configured to send and/or receive signals to determine a geographic location of the mobile device 800. According to various embodiments, the location components 836 can send and/or receive signals from global positioning system (“GPS”) devices, assisted-GPS (“A-GPS”) devices, WI-FI/WIMAX and/or cellular network triangulation data, combinations thereof, and the like. The location component 836 also can be configured to communicate with the communications component 818 to retrieve triangulation data for determining a location of the mobile device 800. In some embodiments, the location component 836 can interface with cellular network nodes, telephone lines, satellites, location transmitters and/or beacons, wireless network transmitters and receivers, combinations thereof, and the like. In some embodiments, the location component 836 can include and/or can communicate with one or more of the sensors 824 such as a compass, an accelerometer, and/or a gyroscope to determine the orientation of the mobile device 800. Using the location component 836, the mobile device 800 can generate and/or receive data to identify its geographic location, or to transmit data used by other devices to determine the location of the mobile device 800. The location component 836 may include multiple components for determining the location and/or orientation of the mobile device 800.

The illustrated mobile device 800 also can include a power source 838. The power source 838 can include one or more batteries, power supplies, power cells, and/or other power subsystems including alternating current (“AC”) and/or direct current (“DC”) power devices. The power source 838 also can interface with an external power system or charging equipment via a power I/O component 840. Because the mobile device 800 can include additional and/or alternative components, the above embodiment should be understood as being illustrative of one possible operating environment for various embodiments of the concepts and technologies described herein. The described embodiment of the mobile device 800 is illustrative, and should not be construed as being limiting in any way.

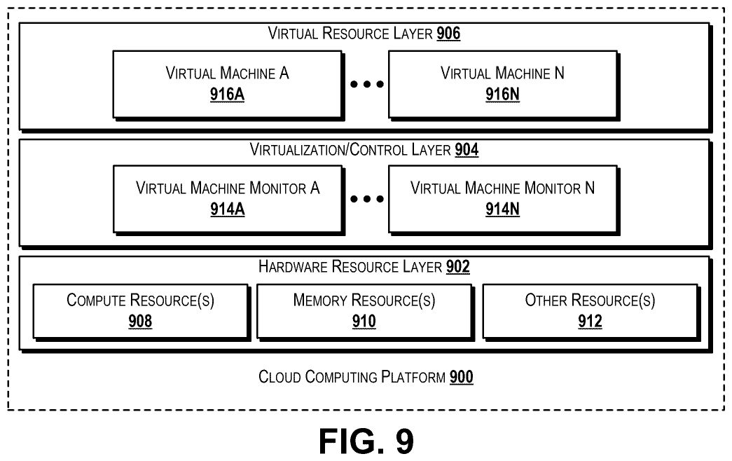

FIG. 9 illustrates an illustrative architecture for a cloud computing platform 900 that can be capable of executing the software components described herein for providing determining and using application limitations during direct-to-cell satellite coverage and/or for interacting with the coverage management application 108 and/or the coverage management service 118. Thus, it can be appreciated that in some embodiments of the concepts and technologies disclosed herein, the cloud computing platform 900 illustrated in FIG. 9 can be used to provide the functionality described herein with respect to the user device 102, the server computer 120, the application feature service 124, the network control 128, and/or the data store 134.

The cloud computing platform 900 thus may be utilized to execute any aspects of the software components presented herein. Thus, according to various embodiments of the concepts and technologies disclosed herein, the coverage management application 108, the coverage management service 118, the application feature service 124, and/or the network control 128, can be implemented, at least in part, on or by elements included in the cloud computing platform 900 illustrated and described herein. Those skilled in the art will appreciate that the illustrated cloud computing platform 900 is a simplification of but only one possible implementation of an illustrative cloud computing platform, and as such, the illustrated cloud computing platform 900 should not be construed as being limiting in any way.

In the illustrated embodiment, the cloud computing platform 900 can include a hardware resource layer 902, a virtualization/control layer 904, and a virtual resource layer 906. These layers and/or other layers can be configured to cooperate with each other and/or other elements of a cloud computing platform 900 to perform operations as will be described in detail herein. While connections are shown between some of the components illustrated in FIG. 9, it should be understood that some, none, or all of the components illustrated in FIG. 9 can be configured to interact with one another to carry out various functions described herein. In some embodiments, the components are arranged so as to communicate via one or more networks such as, for example, the network 104 illustrated and described hereinabove (not shown in FIG. 9). Thus, it should be understood that FIG. 9 and the following description are intended to provide a general understanding of a suitable environment in which various aspects of embodiments can be implemented, and should not be construed as being limiting in any way.

The hardware resource layer 902 can provide hardware resources. In the illustrated embodiment, the hardware resources can include one or more compute resources 908, one or more memory resources 910, and one or more other resources 912. The compute resource(s) 908 can include one or more hardware components that can perform computations to process data, and/or to execute computer-executable instructions of one or more application programs, operating systems, services, and/or other software including, but not limited to, the coverage management application 108, the coverage management service 118, the application feature service 124, and/or the network control 128 illustrated and described herein.

According to various embodiments, the compute resources 908 can include one or more central processing units (“CPUs”). The CPUs can be configured with one or more processing cores. In some embodiments, the compute resources 908 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 908 can include one or more discrete GPUs. In some other embodiments, the compute resources 908 can include one or more CPU and/or GPU components that can be configured in accordance with a co-processing CPU/GPU computing model. Thus, it can be appreciated that in some embodiments of the compute resources 908, a sequential part of an application can execute on a CPU and a computationally-intensive part of the application can be accelerated by the GPU. It should be understood that this example is illustrative, and therefore should not be construed as being limiting in any way.

In some embodiments, the compute resources 908 also can include one or more system on a chip (“SoC”) components. It should be understood that an SoC component can operate in association with one or more other components as illustrated and described herein, for example, one or more of the memory resources 910 and/or one or more of the other resources 912. In some embodiments in which an SoC component is included, the compute resources 908 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 908 can be or can include one or more hardware components arranged in accordance with an ARM architecture, available for license from ARM HOLDINGS of Cambridge, United Kingdom. Alternatively, the compute resources 908 can be or can include one or more hardware components arranged in accordance with an x86 architecture, such as an architecture available from INTEL CORPORATION of Mountain View, California, and others. Those skilled in the art will appreciate the implementation of the compute resources 908 can utilize various computation architectures and/or processing architectures. As such, the various example embodiments of the compute resources 908 as mentioned hereinabove should not be construed as being limiting in any way. Rather, implementations of embodiments of the concepts and technologies disclosed herein can be implemented using compute resources 908 having any of the particular computation architecture and/or combination of computation architectures mentioned herein as well as other architectures.

Although not separately illustrated in FIG. 9, it should be understood that the compute resources 908 illustrated and described herein can host and/or execute various services, applications, portals, and/or other functionality illustrated and described herein. Thus, the compute resources 908 can host and/or can execute the coverage management application 108, the mobile applications 110, the coverage management service 118, the application feature service 124, the network control 128, or other applications or services illustrated and described herein.

The memory resource(s) 910 can include one or more hardware components that can perform or provide storage operations, including temporary and/or permanent storage operations. In some embodiments, the memory resource(s) 910 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 908, subject to the definition of “computer storage media” provided above (e.g., as excluding waves and signals per se and/or communication media as defined in this application).

Although not illustrated in FIG. 9, it should be understood that the memory resources 910 can host or store the various data illustrated and described herein including, but not limited to, the application catalog 122, the network data 126, the device data 130, the user database 132, the coverage data 136, and/or other data, if desired. It should be understood that this example is illustrative, and therefore should not be construed as being limiting in any way.

The other resource(s) 912 can include any other hardware resources that can be utilized by the compute resources(s) 908 and/or the memory resource(s) 910 to perform operations. The other resource(s) 912 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 902 can be virtualized by one or more virtual machine monitors (“VMMs”) 914A-914N (also known as “hypervisors;” hereinafter “VMMs 914”). The VMMs 914 can operate within the virtualization/control layer 904 to manage one or more virtual resources that can reside in the virtual resource layer 906. The VMMs 914 can be or can include software, firmware, and/or hardware that alone or in combination with other software, firmware, and/or hardware, can manage one or more virtual resources operating within the virtual resource layer 906.

The virtual resources operating within the virtual resource layer 906 can include abstractions of at least a portion of the compute resources 908, the memory resources 910, the other resources 912, or any combination thereof. These abstractions are referred to herein as virtual machines (“VMs”). In the illustrated embodiment, the virtual resource layer 906 includes VMs 916A-916N (hereinafter “VMs 916”).

Based on the foregoing, it should be appreciated that systems and methods for providing determining and using application limitations during direct-to-cell satellite coverage have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
obtaining, at a user device, device data associated with the user device, wherein the device data comprises information that can be analyzed to determine an expected geographic location of the user device at a future time,
providing, to a server computer, the device data, wherein the server computer is configured to determine, based on the device data and network data obtained from a network control, the expected geographic location of the user device at the future time and network connections that are expected to be available at the expected geographic location at the future time, wherein the network connections comprise a direct-to-cell satellite network connection,
obtaining, from the server computer, coverage data that represents the network connections that are expected to be available for the user device at the expected geographic location at the future time,
identifying mobile applications that are installed at the user device, one of the mobile applications comprising features,
determining, at the user device and based on the mobile applications and the coverage data, an application limitation that comprises one of the features that is to be limited when the user device is connected to the direct-to-cell satellite network connection, and
generating, at the user device, a user interface comprising a representation of the one of the features that is to be limited when the user device is connected to the direct-to-cell satellite network connection.

2. The system of claim 1, wherein identifying the mobile applications comprises determining features of the mobile applications, the features comprising the one of the features, and wherein determining the features of the mobile applications comprises analyzing the mobile applications.

3. The system of claim 1, wherein identifying the mobile applications comprises determining features of the mobile applications, the features comprising the one of the features, and wherein determining the features of the mobile applications comprises accessing an application catalog.

4. The system of claim 1, wherein the coverage data indicates a time until the user device is connected to the direct-to-cell satellite network connection, wherein the user interface comprises the representation of the one of the features that is to be limited when the user device is connected to the direct-to-cell satellite network connection and the time until the user device is connected to the direct-to-cell satellite network connection, and wherein the user device presents the user interface.

5. The system of claim 1, wherein the computer-executable instructions, when executed by the processor, cause the processor to perform operations further comprising:
determining, based on the coverage data, a first time at which the user device is connected to the direct-to-cell satellite network connection and a second time at which the user device disconnects from the direct-to-cell satellite network connection.

6. The system of claim 5, wherein the computer-executable instructions, when executed by the processor, cause the processor to perform operations further comprising:
presenting the user interface at the user device when the user device is connected to the direct-to-cell satellite network connection, wherein the user interface further comprises a representation of a time until the one of the features that is to be limited when the user device is connected to the direct-to-cell satellite network connection will no longer be limited.

7. The system of claim 1, wherein determining the application limitation comprises determining that all functionality associated with the one of the mobile applications is to be limited when the user device is connected to the direct-to-cell satellite network connection.

8. A method comprising:
obtaining, at a user device comprising a processor, device data associated with the user device, wherein the device data comprises information that can be analyzed to determine an expected geographic location of the user device at a future time;
providing, by the user device and to a server computer, the device data, wherein the server computer is configured to determine, based on the device data and network data obtained from a network control, the expected geographic location of the user device at the future time and network connections that are expected to be available at the expected geographic location at the future time, wherein the network connections comprise a direct-to-cell satellite network connection;
obtaining, by the user device and from the server computer, coverage data that represents the network connections that are expected to be available for the user device at the expected geographic location at the future time;
identifying mobile applications that are installed at the user device, one of the mobile applications comprising features;
determining, at the user device and based on the mobile applications and the coverage data, an application limitation that comprises one of the features that is to be limited when the user device is connected to the direct-to-cell satellite network connection; and
generating, at the user device, a user interface comprising a representation of the one of the features that is to be limited when the user device is connected to the direct-to-cell satellite network connection.

9. The method of claim 8, wherein identifying the mobile applications comprises determining features of the mobile applications, the features comprising the one of the features, and wherein determining the features of the mobile applications comprises analyzing the mobile applications.

10. The method of claim 8, wherein identifying the mobile applications comprises determining features of the mobile applications, the features comprising the one of the features, and wherein determining the features of the mobile applications comprises accessing an application catalog.

11. The method of claim 8, wherein the coverage data indicates a time until the user device is connected to the direct-to-cell satellite network connection, wherein the user interface comprises the representation of the one of the features that is to be limited when the user device is connected to the direct-to-cell satellite network connection and the time until the user device is connected to the direct-to-cell satellite network connection, and wherein the user device presents the user interface.

12. The method of claim 8, further comprising:
determining, based on the coverage data, a first time at which the user device is connected to the direct-to-cell satellite network connection and a second time at which the user device disconnects from the direct-to-cell satellite network connection.

13. The method of claim 12, further comprising:
presenting the user interface at the user device when the user device is connected to the direct-to-cell satellite network connection, wherein the user interface further comprises a representation of a time until the one of the features that is to be limited when the user device is connected to the direct-to-cell satellite network connection will no longer be limited.

14. A computer storage medium having computer-executable instructions stored thereon that, when executed by a processor, cause the processor to perform operations comprising:
obtaining, at a user device, device data associated with the user device, wherein the device data comprises information that can be analyzed to determine an expected geographic location of the user device at a future time;
providing, to a server computer, the device data, wherein the server computer is configured to determine, based on the device data and network data obtained from a network control, the expected geographic location of the user device at the future time and network connections that are expected to be available at the expected geographic location at the future time, wherein the network connections comprise a direct-to-cell satellite network connection;
obtaining, from the server computer, coverage data that represents the network connections that are expected to be available for the user device at the expected geographic location at the future time;
identifying mobile applications that are installed at the user device, one of the mobile applications comprising features;
determining, based on the mobile applications and the coverage data, an application limitation that comprises one of the features that is to be limited when the user device is connected to the direct-to-cell satellite network connection; and
generating a user interface comprising a representation of the one of the features that is to be limited when the user device is connected to the direct-to-cell satellite network connection.

15. The computer storage medium of claim 14, wherein identifying the mobile applications comprises determining features of the mobile applications, the features comprising the one of the features, and wherein determining the features of the mobile applications comprises analyzing the mobile applications.

16. The computer storage medium of claim 14, wherein identifying the mobile applications comprises determining features of the mobile applications, the features comprising the one of the features, and wherein determining the features of the mobile applications comprises accessing an application catalog.

17. The computer storage medium of claim 14, wherein the coverage data indicates a time until the user device is connected to the direct-to-cell satellite network connection, wherein the user interface comprises the representation of the one of the features that is to be limited when the user device is connected to the direct-to-cell satellite network connection and the time until the user device is connected to the direct-to-cell satellite network connection, and wherein the user device presents the user interface.

18. The computer storage medium of claim 14, wherein the computer-executable instructions, when executed by the processor, cause the processor to perform operations further comprising:
determining, based on the coverage data, a first time at which the user device is connected to the direct-to-cell satellite network connection and a second time at which the user device disconnects from the direct-to-cell satellite network connection.

19. The computer storage medium of claim 18, wherein the computer-executable instructions, when executed by the processor, cause the processor to perform operations further comprising:
presenting the user interface at the user device when the user device is connected to the direct-to-cell satellite network connection, wherein the user interface further comprises a representation of a time until the one of the features that is to be limited when the user device is connected to the direct-to-cell satellite network connection will no longer be limited.

20. The computer storage medium of claim 14, wherein determining the application limitation comprises determining that all functionality associated with the one of the mobile applications is to be limited when the user device is connected to the direct-to-cell satellite network connection.
